(19) United States
(12) Patent Application Publication
(10) Pub. No.: US 2026/0128775 A1
(43) Pub. Date: May 7, 2026

(54) METHODS AND APPARATUS FOR PROCESSING CONTROL FRAMES FOR MULTI-AP COLLABORATION

(71) Applicant: HUAWEI TECHNOLOGIES CO., LTD., Shenzhen (CN)

(72) Inventors: Mahmoud Hasabelnaby, Ottawa (CA); Jung Hoon Suh, Ottawa (CA); Yan Xin, Kanata (CA); Sara Norouzi, Vancouver (CA); Osama Aboul-Magd, Ottawa (CA)

(21) Appl. No.: 19/379,204

(22) Filed: Nov. 4, 2025

Related U.S. Application Data
(60) Provisional application No. 63/717,589, filed on Nov. 7, 2024.
(60) Provisional application No. 63/740,753, filed on Dec. 31, 2024.
(60) Provisional application No. 63/742,275, filed on Jan. 6, 2025.
(60) Provisional application No. 63/743,124, filed on Jan. 8, 2025.

(51) Int. Cl. H04B 7/06; H04L 1/00

(52) U.S. Cl. CPC H04B 7/0626; H04B 7/0617; H04L 1/0003

(57) ABSTRACT

Methods and apparatus are disclosed for setting up multi-AP coordinated sounding and beamformed transmission in both single- and multiple-sounding TXOPs. Initial Control trigger frames allocate spatial resources and stations, while Response trigger-based frames confirm participation and exchange multi-AP control information. A MAC-level AID range negotiation method enables APs in overlapping BSSs to prevent duplicate AID assignments. Techniques are further disclosed for sharing sounding control information so that OBSS CSI feedback from STAs can be reliably detected or overheard by participating OBSS APs during coordinated sounding.

### CROSS-REFERENCE TO RELATED APPLICATIONS

The present application claims the benefit of provisional patent applications U.S. 63/717,589 filed Nov. 7, 2024, titled METHODS AND APPARATUS FOR PROCESSING CONTROL FRAMES FOR MULTI-AP COLLABORATION, U.S. 63/740,753 filed Dec. 31, 2024, titled METHODS AND APPARATUS FOR PROCESSING CONTROL FRAMES FOR MULTI-AP COLLABORATION, U.S. 63/742,275 filed Jan. 6, 2025, titled METHODS AND APPARATUS FOR PROCESSING CONTROL FRAMES FOR MULTI-AP COLLABORATION, and U.S. 63/743,124 filed Jan. 8, 2025, titled METHODS AND APPARATUS FOR PROCESSING CONTROL FRAMES FOR MULTI-AP COLLABORATION, the contents of which are incorporated herein by reference in their entireties.

### BACKGROUND

A Wireless LAN according to IEEE 802.11 specifications has at least one Basic Service Set composed of an access point (AP) and one or more non-access point stations (STAs) associated therewith. Beamforming is the systematic driving of pluralities of antennas belonging to one or more APs or STAs to create constructive interference in a primary direction to boost the signal power reaching a target receiver. Basic service sets can be said to overlap when regions of space lie within a useful communication range of more than one Access Point.

In Wireless LAN scenarios with Overlapping Basic Service Sets (OBSSs), coordinated beamforming between Access Points (APs) in overlapping basic service sets (OBSSs) is crucial for improving network efficiency and minimizing interference. By sharing beamforming parameters, APs can enhance signal quality and optimize spatial resource reuse, which is especially important in dense WLAN environments.

For coordinated beamforming to function effectively, it requires coordinated sounding between APs, where key parameters for UHR sounding are exchanged. These parameters include bandwidth (BW) for the Null Data Packet (NDP), punctured channel information, the number of Long Training Fields (NLTF) in the NDP, and the configuration of the P-matrix (which defines the size and structure of spatial streams). APs also need to agree on the starting stream index, the number of spatial streams (Nss), and the specific P-matrix rows to use for coordinated transmission. However, incorporating the UHR sounding parameters into the NDPA frame introduces challenges. The existing frame format lacks the space to include essential information for desired coordinated NDP operations.

Current 802.11 standards do not provide an established method for coordinating the initial sounding phase to efficiently signal control information across multiple APs. This lack of coordination hinders the effective initiation and management of a shared sounding process, impacting the quality and reliability of subsequent beamforming transmissions.

In multi-AP collaboration scenarios, maintaining consistent identification for each Co-BF instance and tracking Co-BF agreements is critical for effective synchronization. However, current protocols lack a standardized method for instance identification and coordination agreement referencing, creating potential conflicts and synchronization issues among APs in a Co-BF group.

Coordinated sounding is one of the key features to realize coordinated beamforming (Co-BF) between two OBSSs. In coordinated sounding, a BSS STA may estimate the DL channel which comes from the OBSS AP, and some signaling in Null-Data PPDU Announcement (NDPA) might be required to trigger an OBSS NDP. However, to prevent the OBSS packet decoding burden on the STA side, NDPA and BFRP Trigger frame are transmitted only towards the in-BSS stations. Therefore, an AP needs to ‘overhear’ the required OBSS channel feedback matrix from the OBSS stations.

When multiple APs serve overlapping STAs, there is a risk of Address Identifier (AID) conflicts, as each AP may assign AIDs independently. Such conflicts can disrupt communication within the Co-BF environment, reducing efficiency and complicating collaboration.

Methods of configuration of coordinated beamforming in a multi-AP collaboration scenario are therefore desired that mitigate one or more deficiencies in the prior art.

### SUMMARY

The present disclosure addresses critical technical challenges that emerge in coordinated beamforming (Co-BF) environments, especially within multi-access point (MAP) collaboration scenarios. In these settings, it is essential to ensure efficient, conflict-free communication between coordinating APs and their associated non-AP STAs to achieve high-performance beamforming transmissions.

The present disclosure proposes the use of a Co-BF Initial Control Frame (ICF) and a Co-BF Initial Control Response (ICR) frame to address the lack of coordination in initial sounding and transmission phases. These frames allow APs within a Co-BF coordination group to communicate essential control information for the coordinated sounding process, as well as identify the specific non-AP STAs they intend to serve. This standardized approach significantly improves the efficiency and reliability of Co-BF transmissions by facilitating a seamless setup process.

The present disclosure introduces the use of the Sounding Dialog Token Number as a Co-BF Instance ID and the inclusion of a MAP Agreement ID within ICF and ICR frames. These identifiers enable APs to track and manage each Co-BF session accurately, minimizing conflicts and supporting a stable, coordinated beamforming environment.

The present disclosure proposes the use of a Co-BF Initial Control Frame (ICF) and a Co-BF Initial Control Response (ICR) frame for exchanging sounding control information of the OBSS CSI feedback transmitted by OBSS STAs to ensure that the CSI feedback can be easily detected or overheard by the OBSS AP participating in the coordinated sounding process.

The present disclosure proposes the use of a NDPA frame for exchanging all or part of sounding control information of the OBSS CSI feedback transmitted by OBSS STAs to ensure that the CSI feedback can be easily detected or overheard by the OBSS AP participating in the coordinated sounding process.

The present disclosure proposes the use of a Beamforming Report Poll (BFRP) or a NDP Feedback Report Poll (NFRP) frame or a NDPA frame to transmit the values of one or more of: the CSI UHR MCS, the CSI NSS, the CSI Target Receive Power, and the AP Tx Power to OBSS STAs to ensure that the CSI feedback can be easily detected or overheard by the OBSS AP participating in the coordinated sounding process.

Additionally, a MAC solution is proposed to resolve STA AID conflicts between overlapping BSSs that may otherwise assign identical AIDs to different STAs. The disclosure proposes a MAC-layer solution where each AP pair in a Co-BF coordination group pre-negotiates non-overlapping AID ranges for their associated STAs. This one-time AID range agreement, facilitated during the MAP Coordination Agreement Negotiation stage, includes an AID Range Negotiation Element and MAP AID Range Negotiation Public Action Frame for signaling. This innovation ensures conflict-free AID allocation, enhancing the reliability and operational efficiency of coordinated beamforming transmissions.

The present disclosure provides a structured approach to enhance coordinated beamforming (Co-BF) in multi-access point (MAP) networks by introducing new control frames, instance identification, and conflict-free address allocation. Embodiments are summarized as follows.

According to some embodiments a method of wireless communication comprises: transmitting, to one or more second access points from a first access point (AP), a trigger frame comprising coordinated beamforming or sounding control information; and receiving, from a second AP, a trigger-based frame comprising an indication of a second AP's readiness to participate in a first coordinated sounding or beamformed transmission.

According to some embodiments the trigger frame comprises a common info trigger type value of 8 corresponding to a ranging trigger frame and a User Field trigger subtype value between 5 and 15 inclusive.

According to some embodiments the trigger frame comprises a common info trigger type value of 2 corresponding to a multiuser block acknowledgement request (BAR) and a BAR type value between 11 and 15 inclusive.

According to some embodiments the trigger frame comprises a common info trigger type value between 9 and 15 inclusive corresponding to a multi-AP coordinated sounding or beamforming request.

According to some embodiments the trigger frame comprises one or more non-AP station (STA) identifiers of STAs scheduled for service by the first AP in the first coordinated sounding or beamformed transmission, and the trigger-based frame comprises one or more STA identifiers of STAs scheduled for service by the second AP in the first coordinated sounding or beamformed transmission.

According to some embodiments the trigger frame comprises a common info trigger type value of 4 corresponding to Buffer Status Report Poll (BSRP) and a User Info List record having a predetermined AID12 value indicative of containing Initial Control Frame control information.

According to some embodiments the trigger frame comprises subfields carrying one or more of: a 6-bit coordinated beamforming instance ID and a 6-bit Multi-AP Agreement ID.

According to some embodiments the trigger frame comprises subfields carrying one or more of: a 2, 3, 4 or 5-bit Channel State Information (CSI) Modulation and Coding Scheme (MCS), a 5, 6, or 7-bit CSI Target Receive Power, a 6, 7, or 8-bit Multi-AP Coordination Agreement ID, and a 5 or 6-bit AP Transmit Power.

According to some embodiments the 5-bit CSI Target Receive Power is assigned a value of: a value between 0 and 30 in the case that Target_{pwr}=−110+3Fᵥₐₗ, wherein Target_{pwr} represents a receive power of an expected received CSI feedback signal, and Fᵥₐₗ represents a value of the 5-bit CSI Target Receive Power; and 31 in the case that a station (STA) transmit the expected received CSI feedback signal at a maximum power for a MSC value assigned by the 2, 3, 4 or 5-bit CSI MCS.

According to some embodiments the 6-bit CSI Target Receive Power is assigned a value of: a value between 0 and 60 in the case that Target_{pwr}=−110+1.5Fᵥₐₗ, wherein Target_{pwr} represents a receive power of an expected received CSI feedback signal, and Fᵥₐₗ represents a value of the 6-bit CSI Target Receive Power; and 63 in the case that a STA transmit the expected received CSI feedback signal at a maximum power for a MSC value assigned by the 2, 3, 4 or 5-bit CSI MCS.

According to some embodiments the 7-bit CSI Target Receive Power is assigned a value of: a value between 0 and 90 in the case that Target_{pwr}=−110+Fᵥₐₗ, wherein Target_{pwr} represents a receive power of an expected received CSI feedback signal, and Fᵥₐₗ represents a value of the 7-bit CSI Target Receive Power; and 127 in the case that a STA transmit the expected received CSI feedback signal at a maximum power for a MSC value assigned by the 2, 3, 4 or 5-bit CSI MCS.

According to some embodiments the 5-bit AP Transmit Power is assigned a value of: a value between 0 and 30 in the case that P_{TX}=−20+2 Fᵥₐₗ, wherein P_{TX} represents a combined transmit power of an AP at a transmit antenna connector of all antennas, and Fᵥₐₗ represents a value of the 5-bit AP Transmit Power.

According to some embodiments the 6-bit AP Transmit Power is assigned a value of: a value between 0 and 60 in the case that P_{TX}=−20+Fᵥₐₗ, wherein P_{TX} represents a combined transmit power of an AP at a transmit antenna connector of all antennas, and Fᵥₐₗ represents a value of the 6-bit AP Transmit Power.

According to some embodiments the trigger frame comprises subfields carrying one or more of: a 6-bit Basic Service Set (BSS) Color, a 7-bit Transmission Opportunity (TXOP), and a 5-bit Punctured Channel Info.

According to some embodiments the trigger-based frame is a MAC Type 1 Control frame of BlockAck subtype 9.

According to some embodiments the indication of a second AP's readiness to participate is a predetermined combination of values of the 1 bit ACK Type and 4 bit TID subfields in a first Per AID TID Info field of the trigger-based frame.

According to some embodiments the trigger-based frame comprises subfields carrying one or more of: a 6-bit multi-AP agreement ID; a 6-bit coordinated beamforming instance ID.

According to some embodiments the trigger-based frame comprises subfields carrying one or more of: a 2, 3, 4 or 5-bit Channel State Information (CSI) Modulation and Coding Scheme (MCS); a 5, 6, or 7-bit CSI Target Receive Power; a 6, 7, or 8-bit Multi-AP Coordination Agreement ID; a 5 or 6-bit AP Transmit Power.

According to some embodiments the 5-bit CSI Target Receive Power is assigned a value of: a value between 0 and 30 in the case that Target_{pwr}=−110+3Fᵥₐₗ, wherein Target_{pwr} represents a receive power of an expected received CSI feedback signal, and Fᵥₐₗ represents a value of the 5-bit CSI Target Receive Power; and 31 in the case that a station (STA) transmit the expected received CSI feedback signal at a maximum power for a MSC value assigned by the 2, 3, 4 or 5-bit CSI MCS.

According to some embodiments the 6-bit CSI Target Receive Power is assigned a value of: a value between 0 and 60 in the case that Target_{pwr}=−110+1.5Fᵥₐₗ, wherein Target_{pwr} represents a receive power of an expected received CSI feedback signal, and Fᵥₐₗ represents a value of the 6-bit CSI Target Receive Power; and 63 in the case that a STA transmit the expected received CSI feedback signal at a maximum power for a MSC value assigned by the 2, 3, 4 or 5-bit CSI MCS.

According to some embodiments the 7-bit CSI Target Receive Power is assigned a value of: a value between 0 and 90 in the case that Target_{pwr}=−110+Fᵥₐₗ, wherein Target_{pwr} represents a receive power of an expected received CSI feedback signal, and Fᵥₐₗ represents a value of the 7-bit CSI Target Receive Power; and 127 in the case that a STA transmit the expected received CSI feedback signal at a maximum power for a MSC value assigned by the 2, 3, 4 or 5-bit CSI MCS.

According to some embodiments the 5-bit AP Transmit Power is assigned a value of: a value between 0 and 30 in the case that P_{TX}=−20+2 Fᵥₐₗ, wherein P_{TX} represents a combined transmit power of an AP at a transmit antenna connector of all antennas, and Fᵥₐₗ represents a value of the 5-bit AP Transmit Power.

According to some embodiments the 6-bit AP Transmit Power is assigned a value of: a value between 0 and 60 in the case that P_{TX}=−20+Fᵥₐₗ, wherein P_{TX} represents a combined transmit power of an AP at a transmit antenna connector of all antennas, and Fᵥₐₗ represents a value of the 6-bit AP Transmit Power.

According to some embodiments the method further comprises: transmitting, to a STA from the first AP, a first NDP Feedback Report Poll (NFRP) frame comprising one or more of: the 2, 3, 4 or 5-bit CSI MCS, the 5, 6, or 7-bit CSI Target Receive Power and the 5 or 6-bit AP Transmit Power.

According to some embodiments the method further comprises: transmitting, to a STA from the first AP, a second NFRP frame comprising a transmit power for the STA to transmit a CSI report frame, wherein the transmit power is determined by the first AP based on one or more of the 2, 3, 4 or 5-bit CSI MCS, the 5, 6, or 7-bit CSI Target Receive Power and the 5 or 6-bit AP Transmit Power.

According to some embodiments the method further comprises: transmitting, to a STA from the first AP, a first Beamforming Report Poll (BFRP) frame comprising one or more of: the 2, 3, 4 or 5-bit CSI MCS, the 5, 6, or 7-bit CSI Target Receive Power and the 5 or 6-bit AP Transmit Power.

According to some embodiments the method further comprises: transmitting, to a STA from the first AP, a second BFRP frame comprising a transmit power for the STA to transmit a CSI report frame, wherein the transmit power is determined by the first AP based on one or more of: the 2, 3, 4 or 5-bit CSI MCS, the 5, 6, or 7-bit CSI Target Receive Power, and the 5 or 6-bit AP Transmit Power.

According to some embodiments the trigger-based frame comprises subfields carrying one or more of: a 6-bit Basic Service Set (BSS) Color; a 7-bit Transmission Opportunity (TXOP); a 5-bit Punctured Channel Info.

According to some embodiments the trigger-based frame comprises a BlockAck bitmap field and a starting sequence number, the first four bits of the starting sequence number being assigned a value of: 0 in the case that the BlockAck bitmap field contains Co-BF or coordinated sounding parameters; and a value between 1 and 15 in the case that the BlockAck bitmap field contains control information for In-Device Coexistence (IDC), Link Adaptation, MAP coordination, Intermediate FCS, Non-Primary Channel Access (NPCA), or Dynamic Sub-band Operation (DSO).

According to some embodiments a communication method between a first AP and a second AP comprises: transmitting, from the first AP to the second AP, a first Null-Data PPDU Announcement (NDPA) frame comprising first sounding control information; and/or receiving, from the second AP to the first AP, a second NDPA frame comprising second sounding control information.

According to some embodiments the first NDPA frame or the second NDPA frame comprises subfields carrying one or more of: a 2, 3, 4 or 5-bit Channel State Information (CSI) Modulation and Coding Scheme (MCS); a 5, 6, or 7-bit CSI Target Receive Power; a 5 or 6-bit AP Transmit Power.

According to some embodiments the first NDPA frame or the second NDPA frame comprises a first field and a second field, and the first field or the second field carrying one or more of: a 2, 3, 4 or 5-bit CSI MCS; a 5, 6, or 7-bit CSI Target Receive Power; a 5 or 6-bit AP Transmit Power.

According to some embodiments the method further comprises: transmitting, from the first AP to a station (STA), a third NDPA frame comprising subfields carrying one or more of: a 2, 3, 4 or 5-bit CSI MCS; a 5, 6, or 7-bit CSI Target Receive Power; a 5 or 6-bit AP Transmit Power.

According to some embodiments the method further comprises: transmitting, from the first AP to the STA, a third Beamforming Report Poll (BFRP) frame comprising one or more of: a 2, 3, 4 or 5-bit CSI MCS and a 5, 6, or 7-bit CSI Target Receive Power comprised in a fourth NDPA frame transmitted by the second AP and a 5 or 6-bit AP Transmit Power comprised in a fourth BFRP frame transmitted by the second AP.

According to some embodiments the method further comprises: transmitting, from the first AP to the STA, a fifth BFRP frame comprising one or more of: a 2, 3, 4 or 5-bit CSI MCS, a 5, 6, or 7-bit CSI Target Receive Power and a 5 or 6-bit AP Transmit Power comprised in a sixth BFRP frame transmitted by the second AP.

According to some embodiments the 5-bit CSI Target Receive Power is assigned a value of: a value between 0 and 30 in the case that Target_{pwr}=−110+3Fᵥₐₗ, wherein Target_{pwr} represents a receive power of an expected received CSI feedback signal, and Fᵥₐₗ represents a value of the 5-bit CSI Target Receive Power; and 31 in the case that a station (STA) transmit the expected received CSI feedback signal at a maximum power for a MSC value assigned by the 2, 3, 4 or 5-bit CSI MCS.

According to some embodiments the 6-bit CSI Target Receive Power is assigned a value of: a value between 0 and 60 in the case that Target_{pwr}=−110+1.5Fᵥₐₗ, wherein Target_{pwr} represents a receive power of an expected received CSI feedback signal, and Fᵥₐₗ represents a value of the 6-bit CSI Target Receive Power; and 63 in the case that a STA transmit the expected received CSI feedback signal at a maximum power for a MSC value assigned by the 2, 3, 4 or 5-bit CSI MCS.

According to some embodiments the 7-bit CSI Target Receive Power is assigned a value of: a value between 0 and 90 in the case that Target_{pwr}=−110+Fᵥₐₗ, wherein Target_{pwr} represents a receive power of an expected received CSI feedback signal, and Fᵥₐₗ represents a value of the 7-bit CSI Target Receive Power; and 127 in the case that a STA transmit the expected received CSI feedback signal at a maximum power for a MSC value assigned by the 2, 3, 4 or 5-bit CSI MCS.

According to some embodiments the 5-bit AP Transmit Power is assigned a value of: a value between 0 and 30 in the case that P_{TX}=−20+2 Fᵥₐₗ, wherein P_{TX} represents a combined transmit power of an AP at a transmit antenna connector of all antennas, and Fᵥₐₗ represents a value of the 5-bit AP Transmit Power.

According to some embodiments the 6-bit AP Transmit Power is assigned a value of: a value between 0 and 60 in the case that P_{TX}=−20+Fᵥₐₗ, wherein P_{TX} represents a combined transmit power of an AP at a transmit antenna connector of all antennas, and Fᵥₐₗ represents a value of the 6-bit AP Transmit Power.

According to some embodiments the first NDPA frame or the second NDPA frame comprises subfields carrying one or more of: a 4 or 5-bit Channel State Information (CSI) Modulation and Coding Scheme (MCS); a 2, 3, or 4-bit CSI Number of Spatial Streams (NSS).

According to some embodiments the first NDPA frame or the second NDPA frame comprises a first field and a second field, and the first field or the second field carrying one or more of: a 4 or 5-bit Channel State Information (CSI) Modulation and Coding Scheme (MCS); a 2, 3, or 4-bit CSI Number of Spatial Streams (NSS).

According to some embodiments a value corresponding to one or more of the 4 or 5-bit CSI MCS, the 2, 3, or 4-bit CSI NSS is set to a value required by an Overlapping Basic Service Set (OBSS) AP.

According to some embodiments a value corresponding to one or more of: the 2, 3, 4 or 5-bit CSI MCS, the 5, 6, or 7-bit CSI Target Receive Power, and the 5 or 6-bit AP Transmit Power is set to a value required by the first AP.

According to some embodiments a value corresponding to one or more of the 2, 3, 4 or 5-bit CSI MCS, the 5, 6, or 7-bit CSI Target Receive Power, and the 5 or 6-bit AP Transmit Power is set to a value required by an AP which transmits a NDPA frame.

According to some embodiments a value corresponding to one or more of the 2, 3, 4 or 5-bit CSI MCS, the 5, 6, or 7-bit CSI Target Receive Power, and the 5 or 6-bit AP Transmit Power is set to a value required by an Overlapping Basic Service Set (OBSS) AP.

According to some embodiments a wireless communication comprises: receiving, by a station (STA) from a first access point (AP) or a second AP, a first frame comprising coordinated sounding control information; and transmitting, by the STA, a Channel State Information (CSI) report frame with a transmit power determined by the STA according to the coordinated sounding control information.

According to come embodiments the first frame comprises a Beamforming Report Poll (BFRP), or a NDP Feedback Report Poll (NFRP) frame, or a Null-Data PPDU Announcement (NDPA) frame.

According to some embodiments the coordinated sounding control information comprises one or more of: a 2, 3, 4 or 5-bit CSI Modulation and Coding Scheme (MCS), a 5, 6, or 7-bit CSI Target Receive Power and a 5 or 6-bit AP Transmit Power received by the first AP from the second AP or received by the second AP from the first AP.

According to some embodiments the transmit power is calculated based on the following equation:

$${Tx}_{pwr}^{STA} = {PL}_{DL} + {TargetRx}_{pwr}$$

wherein the

$${Tx}_{pwr}^{STA}$$

represents the TX power, the TargetRx_{pwr} represents a value corresponding to the 5, 6, or 7-bit CSI Target Receive Power, and the PL_{DL} represents a downlink pathloss between the STA and the second AP.

According to some embodiments the PL_{DL} is calculated based on the 5 or 6-bit AP Transmit Power.

According to some embodiments the coordinated sounding control information comprises a transmit power for the STA to transmit a CSI report frame, wherein the transmit power is determined by the first AP based on one or more of a 2, 3, 4 or 5-bit CSI MCS, a 5, 6, or 7-bit CSI Target Receive Power, and a 5 or 6-bit AP Transmit Power received by the first AP from the second AP or received by the second AP from the first AP.

According to some embodiments the method further comprises: receiving, by the STA from the first AP, a third NDPA frame comprising subfields carrying one or more of: a 2, 3, 4 or 5-bit CSI MCS; a 5, 6, or 7-bit CSI Target Receive Power; a 5 or 6-bit AP Transmit Power.

According to some embodiments the method further comprises: receiving, by the STA from the first AP, a third BFRP frame comprising one or more of: a 2, 3, 4 or 5-bit CSI MCS and a 5, 6, or 7-bit CSI Target Receive Power comprised in a fourth NDPA frame transmitted by the second AP and a 5 or 6-bit AP Transmit Power comprised in a fourth BFRP frame transmitted by the second AP.

According to some embodiments the method further comprises: receiving, by the STA from the first AP, a fifth BFRP frame comprising one or more of: a 2, 3, 4 or 5-bit CSI MCS, a 5, 6, or 7-bit CSI Target Receive Power and a 5 or 6-bit AP Transmit Power comprised in a sixth BFRP frame transmitted by the second AP.

According to some embodiments the 5-bit CSI Target Receive Power is assigned a value of: a value between 0 and 30 in the case that Target_{pwr}=−110+3Fᵥₐₗ, wherein Target_{pwr} represents a receive power of an expected received CSI feedback signal, and Fᵥₐₗ represents a value of the 5-bit CSI Target Receive Power; and 31 in the case that a station (STA) transmit the expected received CSI feedback signal at a maximum power for a MSC value assigned by the 2, 3, 4 or 5-bit CSI MCS.

According to some embodiments the 6-bit CSI Target Receive Power is assigned a value of: a value between 0 and 60 in the case that Target_{pwr}=−110+1.5Fᵥₐₗ, wherein Target_{pwr} represents a receive power of an expected received CSI feedback signal, and Fᵥₐₗ represents a value of the 6-bit CSI Target Receive Power; and 63 in the case that a STA transmit the expected received CSI feedback signal at a maximum power for a MSC value assigned by the 2, 3, 4 or 5-bit CSI MCS.

According to some embodiments the 7-bit CSI Target Receive Power is assigned a value of: a value between 0 and 90 in the case that Target_{pwr}=−110+Fᵥₐₗ, wherein Target_{pwr} represents a receive power of an expected received CSI feedback signal, and Fᵥₐₗ represents a value of the 7-bit CSI Target Receive Power; and 127 in the case that a STA transmit the expected received CSI feedback signal at a maximum power for a MSC value assigned by the 2, 3, 4 or 5-bit CSI MCS.

According to some embodiments the 5-bit AP Transmit Power is assigned a value of: a value between 0 and 30 in the case that P_{TX}=−20+2 Fᵥₐₗ, wherein P_{TX} represents a combined transmit power of an AP at a transmit antenna connector of all antennas, and Fᵥₐₗ represents a value of the 5-bit AP Transmit Power.

According to some embodiments the 6-bit AP Transmit Power is assigned a value of: a value between 0 and 60 in the case that P_{TX}=−20+Fᵥₐₗ, wherein P_{TX} represents a combined transmit power of an AP at a transmit antenna connector of all antennas, and Fᵥₐₗ represents a value of the 6-bit AP Transmit Power.

According to some embodiments a value corresponding to one or more of: the 2, 3, 4 or 5-bit CSI MCS, the 5, 6, or 7-bit CSI Target Receive Power, and the 5 or 6-bit AP Transmit Power is set to a value required by the first AP.

According to some embodiments a value corresponding to one or more of the 2, 3, 4 or 5-bit CSI MCS, the 5, 6, or 7-bit CSI Target Receive Power, and the 5 or 6-bit AP Transmit Power is set to a value required by an AP which transmits a NDPA frame.

According to some embodiments a value corresponding to one or more of the 2, 3, 4 or 5-bit CSI MCS, the 5, 6, or 7-bit CSI Target Receive Power, and the 5 or 6-bit AP Transmit Power is set to a value required by an Overlapping Basic Service Set (OBSS) AP.

According to some embodiments, a method of wireless communication comprises: receiving, by a station (STA) from a first access point (AP) or a second AP, a first frame comprising coordinated sounding control information; and transmitting, by the STA, a Channel State Information (CSI) report frame with a Modulation and Coding Scheme (MCS) level determined by the STA according to the coordinated sounding control information in the first frame.

According to some embodiments the first frame comprises a Beamforming Report Poll (BFRP), or a NDP Feedback Report Poll (NFRP) frame, or a Null-Data PPDU Announcement (NDPA) frame.

According to some embodiments the coordinated sounding control information comprises one or more of: a 2, 3, 4 or 5-bit CSI MCS and a 2, 3, or 4-bit CSI Number of Spatial Streams (NSS), received by the first AP from the second AP or received by the second AP from the first AP.

According to some embodiments the STA transmits the CSI report frame using a maximum transmit power allowed in IEEE 802.11 for the MCS level determined by the STA.

According to some embodiments the method further comprises: receiving, by the STA from the first AP, a third NDPA frame comprising subfields carrying one or more of: a 2, 3, 4 or 5-bit CSI MCS; a 2, 3, or 4-bit CSI NSS.

According to some embodiments a value corresponding to one or more of: the 2, 3, 4 or 5-bit CSI MCS, the 2, 3, or 4-bit CSI NSS, is set to a value required by the first AP.

According to some embodiments a value corresponding to one or more of: the 2, 3, 4 or 5-bit CSI MCS, the 2, 3, or 4-bit CSI NSS, is set to a value required by an AP which transmits a NDPA frame.

According to some embodiments a value corresponding to one or more of: the 2, 3, 4 or 5-bit CSI MCS, the 2, 3, or 4-bit CSI NSS, is set to a value required by an Overlapping Basic Service Set (OBSS) AP.

According to some embodiments a method of allocating association ID ranges between a first AP and a second AP comprises: transmitting, from the first AP to the second AP a first public action frame, the first public action frame comprising a request type subfield and two AID range boundary subfields, the request type subfield carrying a value indicative that the two AID range boundary subfields bound a range of AIDs suggested to be allocated to the second AP; and receiving, from the second AP, a second public action frame, the second public action frame comprising a request type subfield and two AID range boundary subfields, the request type subfield carrying a value indicative that the two AID range boundary subfields bound a range of AIDs which is one of: accepted to be allocated to the second AP, a modification of a range suggested for allocation to the second AP, or rejected for allocation to the second AP.

According to some embodiments a first access point (AP), comprises: a transmitting module, configured to transmit, to one or more second access points, a trigger frame comprising coordinated beamforming or sounding control information; and a receiving module, configured to receive, from a second AP, a trigger-based frame comprising an indication of a second AP's readiness to participate in a first coordinated sounding or beamformed transmission.

According to some embodiments a first access point (AP), comprises: a transmitting module, configured to transmit, to a second AP, a first Null-Data PPDU Announcement (NDPA) frame comprising first sounding control information; and/or a receiving module, configured to receive, from the second AP, a second NDPA frame comprising second sounding control information.

According to some embodiments a first access point (AP) for allocating association ID ranges between a first AP and a second AP, comprises: a transmitting module, configured to transmit, to the second AP a first public action frame, the first public action frame comprising a request type subfield and two AID range boundary subfields, the request type subfield carrying a value indicative that the two AID range boundary subfields bound a range of AIDs suggested to be allocated to the second AP; and a receiving module, configured to receive, from the second AP, a second public action frame, the second public action frame comprising a request type subfield and two AID range boundary subfields, the request type subfield carrying a value indicative that the two AID range boundary subfields bound a range of AIDs which is one of: accepted to be allocated to the second AP, a modification of a range suggested for allocation to the second AP, or rejected for allocation to the second AP.

According to some embodiments a station (STA) comprises: a receiving module, configured to receive, from a first access point (AP) or a second AP, a first frame comprising coordinated sounding control information; and a transmitting module, configured to transmit a CSI report frame with a transmit power determined by the STA according to the coordinated sounding control information.

According to some embodiments a first access point (AP), comprises at least one processor coupled to a memory storing a set of instructions; wherein the at least one processor is configured to read the set of instructions in the memory and execute any of the methods described herein.

According to some embodiments a station (STA), comprises at least one processor coupled to a memory storing a set of instructions; wherein the at least one processor is configured to read the set of instructions in the memory and execute any of the methods described herein.

According to some embodiments a communication system, comprises any first access point (AP) as described herein.

According to some embodiments a communication system, comprises any first access point (AP) as described herein and any station (STA) as described herein.

According to some embodiments a computer-readable storage medium has instructions stored thereon which, when executed by an apparatus, enable the apparatus to perform any of the methods described herein.

According to some embodiments a computer program product stores instructions which, when executed, cause an apparatus to perform any one of the methods described herein.

According to some embodiments, a method of wireless communication comprises: transmitting, to one or more second access points from a first access point (AP), a trigger frame comprising coordinated sounding or beamforming control information; and receiving, from a second AP, a trigger-based frame comprising an indication of a second AP's readiness to participate in a first coordinated sounding or beamforming transmission.

According to some embodiments, the trigger frame comprises a common info trigger type value of 8 corresponding to a ranging trigger frame and a User Field trigger subtype value between 5 and 15 inclusive.

According to some embodiments, the trigger frame comprises a common info trigger type value of 2 corresponding to a multiuser block acknowledgement request (BAR) and a BAR type value between 11 and 15 inclusive.

According to some embodiments, the trigger frame comprises a common info trigger type value between 9 and 15 inclusive corresponding to a multi-AP coordinated sounding or beamforming request.

According to some embodiments: the trigger frame comprises one or more non-AP station (STA) identifiers of STAs scheduled for service by the first AP in the first coordinated sounding or beamforming transmission, and the trigger-based frame comprises one or more STA identifiers of STAs scheduled for service by the second AP in the first coordinated sounding or beamforming transmission.

According to some embodiments, the trigger frame comprises a common info trigger type value of 4 corresponding to Buffer Status Report Poll (BSRP) and a User Info List record having a predetermined AID12 value indicative of containing Initial Control Frame control information.

According to some embodiments, the trigger frame comprises subfields carrying one or more of: a 6-bit coordinated beamforming instance ID and a 6-bit Multi-AP Agreement ID.

According to some embodiments, the trigger frame comprises subfields carrying one or more of: a 5-bit Channel State Information (CSI) Modulation and Coding Scheme (MCS), a 5, 6, or 7-bit CSI Target Receive Power, a 6, 7, or 8-bit Multi-AP Coordination Agreement ID, and a 5 or 6-bit AP Transmit Power.

According to some embodiments, the 5-bit CSI Target Receive Power being assigned a value of: a value between 0 and 30 in the case that Target_{pwr}=−110+3Fᵥₐₗ, wherein Target_{pwr} represents a receive power of an expected received CSI feedback signal, and Fᵥₐₗ represents a value of the 5-bit CSI Target Receive Power; and 31 in the case that a station (STA) transmit the expected received CSI feedback signal at a maximum power for a MSC value assigned by the 2, 3, 4 or 5-bit CSI MCS.

According to some embodiments, the 6-bit CSI Target Receive Power being assigned a value of: a value between 0 and 60 in the case that Target_{pwr}=−110+1.5Fᵥₐₗ, wherein Target_{pwr} represents a receive power of an expected received CSI feedback signal, and Fᵥₐₗ represents a value of the 6-bit CSI Target Receive Power; and 63 in the case that a STA transmit the expected received CSI feedback signal at a maximum power for a MSC value assigned by the 2, 3, 4 or 5-bit CSI MCS.

According to some embodiments, the 7-bit CSI Target Receive Power being assigned a value of: a value between 0 and 90 in the case that Target_{pwr}=−110+Fᵥₐₗ, wherein Target_{pwr} represents a receive power of an expected received CSI feedback signal, and Fᵥₐₗ represents a value of the 7-bit CSI Target Receive Power; and 127 in the case that a STA transmit the expected received CSI feedback signal at a maximum power for a MSC value assigned by the 2, 3, 4 or 5-bit CSI MCS.

According to some embodiments, the 5-bit AP Transmit Power being assigned a value of: a value between 0 and 30 in the case that P_{TX}=−20+2 Fᵥₐₗ, wherein P_{TX} represents a combined transmit power of an AP at a transmit antenna connector of all antennas, and Fᵥₐₗ represents a value of the 5-bit AP Transmit Power.

According to some embodiments, the 6-bit AP Transmit Power being assigned a value of: a value between 0 and 60 in the case that P_{TX}=−20+Fᵥₐₗ, wherein P_{TX} represents a combined transmit power of an AP at a transmit antenna connector of all antennas, and Fᵥₐₗ represents a value of the 6-bit AP Transmit Power.

According to some embodiments, the trigger frame comprises subfields carrying one or more of: a 6-bit Basic Service Set (BSS) Color, a 7-bit Transmission Opportunity (TXOP), a 3-bit Bandwidth, and a 5-bit Punctured Channel Info.

According to some embodiments, the trigger-based frame is a MAC Type 1 Control frame of BlockAck subtype 9.

According to some embodiments, identification of the trigger-based frame as an ICR response is based on a predetermined combination of values of the 1 bit ACK Type and 4 bit TID subfields in a first Per AID TID Info field of the trigger-based frame.

According to some embodiments, the trigger-based frame comprises subfields carrying one or more of: a 6-bit multi-AP agreement ID; a 6-bit coordinated beamforming instance ID.

According to some embodiments, the trigger-based frame comprises subfields carrying one or more of: a 6-bit Basic Service Set (BSS) Color; a 7-bit Transmission Opportunity (TXOP); a 5-bit Punctured Channel Info.

According to some embodiments, the trigger-based frame comprises a BlockAck bitmap field and a starting sequence number, wherein four bits of the starting sequence number are assigned a value of: a unified value in the case that the BlockAck bitmap field contains Co-BF or coordinated sounding parameters; and one or more other values in the case that the BlockAck bitmap field contains control information for In-Device Coexistence (IDC), Link Adaptation, MAP coordination, Intermediate FCS, Non-Primary Channel Access (NPCA), or Dynamic Sub-band Operation (DSO).

According to some embodiments, the trigger frame further comprises information indicative of one or more of: bandwidth and punctured channel information; a number of long training fields (NLTF) in a null data packet (NDP); a starting stream index and a number of spatial streams (NSS); a guard interval (GI) and UHR long training field (LTF) type; a transmission opportunity (TXOP) duration; and a transmit error vector magnitude (EVM).

According to some embodiments, the trigger frame is a Buffer Status Report Poll (BSRP) frame.

According to some embodiments, the BSRP frame has a trigger type subfield set to a value of 4 so that the BSRP frame is used as a coordinated beamforming initial control frame (ICF).

According to some embodiments, the BSRP frame includes at least one user information field dedicated to initial control frame (ICF) information.

According to some embodiments, the user information field comprises an AID12 field having a fixed value identifying the user information field as an ICF information field.

According to some embodiments, the AID12 field contains a shared access point (AP) identifier assigned by a sharing AP to a shared AP during a multi-AP coordination agreement negotiation phase.

According to some embodiments, the user information field is positioned immediately after a special information info field when the fixed value is between 1 and 2006, and following a user information list when the fixed value is greater than 2007.

According to some embodiments, the user information field further comprises an ICF type field specifying one or more of: coordinated beamforming (Co-BF) or coordinated sounding; coordinated spatial reuse (Co-SR); coordinated TDMA (Co-TDMA); coordinated restricted target wake time (Co-rTWT); in-device coexistence (IDC); dynamic sub-band operation (DSO); non-primary channel access (NPCA); and dynamic power save (DPS).

According to some embodiments, the user information field comprises an extension flag bit indicating the presence of an extended ICF information field.

According to some embodiments, the ICF type field is allocated an unassigned value from 0 to 15, including 0 or 1, to designate a coordinated beamforming (Co-BF) or coordinated sounding ICF.

According to some embodiments, the extended ICF information field comprises 6 bits for a MAP agreement identifier, 6 bits for a Co-BF instance identifier, and 5 bits for punctured channel information.

According to some embodiments, the punctured channel information is encoded in a 5-bit field consistent with Table 36-30 of IEEE 802.11be-2024 defining punctured channel information in the U-SIG for an EHT MU PPDU using non-OFDMA transmissions.

According to some embodiments, the trigger-based frame is implemented as a multi-STA block acknowledgment (BA) frame comprising one or more Per AID TID information fields, each Per AID TID information field including an AID subfield, an acknowledgment type subfield, a traffic identifier (TID) subfield, and a block acknowledgment bitmap, the fields being used to convey coordinated beamforming control information in addition to acknowledgment.

According to some embodiments, a communication method between a first AP and a second AP comprises: transmitting, from the first AP to the second AP, a first Null-Data PPDU Announcement (NDPA) frame comprising first sounding control information; and/or receiving, from the second AP to the first AP, a second NDPA frame comprising second sounding control information.

According to some embodiments, one or more of the first NDPA frame and the second NDPA frame comprises subfields carrying one or more of: a 5-bit Channel State Information (CSI) Modulation and Coding Scheme (MCS); a 5, 6, or 7-bit CSI Target Receive Power; and a 5 or 6-bit AP Transmit Power.

According to some embodiments, the first NDPA frame or the second NDPA frame comprises a first special station info field and a second special station info field, and the second special station info field carrying one or more of: a 5-bit CSI MCS; a 5, 6, or 7-bit CSI Target Receive Power; and a 5 or 6-bit AP Transmit Power.

According to some embodiments, the method further comprises: transmitting, from the first AP to a station (STA), a third NDPA frame comprising subfields carrying one or more of: a 5-bit CSI MCS; a 5, 6, or 7-bit CSI Target Receive Power; and a 5 or 6-bit AP Transmit Power.

According to some embodiments, the method further comprises: transmitting, from the first AP to the STA, a third Beamforming Report Poll (BFRP) frame comprising one or more of: a 5-bit CSI MCS and a 5, 6, or 7-bit CSI Target Receive Power comprised in a fourth NDPA frame transmitted by the second AP and a 5 or 6-bit AP Transmit Power comprised in a fourth BFRP frame transmitted by the second AP.

According to some embodiments, the method further comprises: transmitting, from the first AP to the STA, a fifth BFRP frame comprising one or more of: a 5-bit CSI MCS, a 5, 6, or 7-bit CSI Target Receive Power and a 5 or 6-bit AP Transmit Power comprised in a sixth BFRP frame transmitted by the second AP.

According to some embodiments, a value corresponding to one or more of the 5-bit CSI MCS, the 5, 6, or 7-bit CSI Target Receive Power, and the 5 or 6-bit AP Transmit Power is set to a value required by an AP which transmits a NDPA frame.

According to some embodiments, the null data packet announcement (NDPA) frame comprises first and second special STA information fields positioned immediately after a sounding dialog token field and before a list of STA information fields.

According to some embodiments, the second special STA information field comprises a shared access point (AP) association identifier (AID11) assigned during a multi-AP coordination negotiation phase.

According to some embodiments, the second special STA information field further comprises one or more of: a starting spatial stream indicator; a number of spatial streams (NSS) indicator; a guard interval (GI) and UHR long training field (LTF) type indicator; and a number of long training fields (NLTF); and a disambiguation bit set to 1 to prevent misdetection of the AID by legacy devices.

According to some embodiments, the second special STA information field further comprises a disambiguation bit set to 1 to prevent misdetection of a shared access point association identifier by legacy devices.

According to some embodiments, the second special STA information field further comprises a recommended CSI UHR modulation and coding scheme (MCS) field and a CSI NSS field, wherein values in the recommended fields are set according to a worst-case scenario across overlapping basic service set (OBSS) stations.

According to some embodiments, the recommended CSI UHR MCS field is 5 bits located at bit B20-B24 in the second special STA information field.

According to some embodiments, in a sequential or joint sounding process, the second special STA information field of an NDPA frame transmitted by a sharing AP specifies a required CSI UHR MCS level and CSI NSS for a shared AP to include in the shared AP's subsequent beamforming report poll (BFRP) to request CSI feedback from its associated stations.

According to some embodiments, in a subsequent phase of the sequential or joint sounding process, the second special STA info field of an NDPA frame transmitted by the shared AP specifies a required CSI UHR MCS level and CSI NSS for the sharing AP to include in the sharing AP's BFRP to request CSI feedback from its associated stations.

According to some embodiments, the first NDPA frame includes a second special station (STA) information field that specifies a required overlapping basic service set (OBSS) channel state information (CSI) modulation and coding scheme (MCS) level and a CSI number of spatial streams (NSS) that the second AP is to include in its beamforming report poll (BFRP) to request CSI feedback from its associated STAs.

According to some embodiments, the second NDPA frame includes the second special STA information field specifying a required OBSS CSI MCS level and CSI NSS that the first AP is to include in its BFRP to request CSI feedback from its associated STAs.

According to some embodiments, after a coordinated beamforming (Co-BF) agreement is established, the first AP and the second AP refine the recommended CSI MCS and CSI NSS values based on overheard OBSS CSI reports from nearby non-AP stations.

According to some embodiments, during an initial coordinated beamforming sounding process the first AP and the second AP set the recommended CSI MCS field to 31 and subsequently update the field based on overheard OBSS CSI reports to improve overhearing reliability in later sounding sequences.

According to some embodiments, a method of wireless communication comprises: receiving, by a station (STA) from a first access point (AP) or a second AP, a first frame comprising coordinated sounding control information; and transmitting, by the STA, a Channel State Information (CSI) report frame with a Modulation and Coding Scheme (MCS) level set by the STA according to the coordinated sounding control information in the first frame.

According to some embodiments, the first frame comprises a Beamforming Report Poll (BFRP).

According to some embodiments, the coordinated sounding control information comprises one or more of: a 5-bit CSI MCS and a 2, 3, or 4-bit CSI Number of Spatial Streams (NSS), received by the first AP from the second AP or received by the second AP from the first AP.

According to some embodiments, the STA transmits the CSI report frame using a maximum transmit power allowed in IEEE 802.11 for the MCS level determined by the STA.

According to some embodiments, the method further comprises: receiving, by the STA from the first AP, a third NDPA frame comprising subfields carrying one or more of: a 5-bit CSI MCS; and a 2, 3, or 4-bit CSI NSS.

According to some embodiments, a value corresponding to one or more of: the 5-bit CSI MCS, the 2, 3, or 4-bit CSI NSS, is set to a value required by an AP which transmits a NDPA frame.

According to some embodiments, a first access point (AP) comprises: a transmitting module, configured to transmit, to one or more second access points, a trigger frame comprising coordinated sounding or beamforming control information; and a receiving module, configured to receive, from a second AP, a trigger-based frame comprising an indication of a second AP's readiness to participate in a first coordinated sounding or beamforming transmission.

According to some embodiments, a first access point (AP), comprises: a transmitting module, configured to transmit, to a second AP, a first Null-Data PPDU Announcement (NDPA) frame comprising first sounding control information; and/or a receiving module, configured to receive, from the second AP, a second NDPA frame comprising second sounding control information.

According to some embodiments, a communication method comprises: transmitting, from a first AP to a second AP, a first Null-Data PPDU Announcement (NDPA) frame comprising first sounding control information; and/or receiving, from the second AP to the first AP, a second NDPA frame comprising second sounding control information, wherein the first NDPA frame or the second NDPA frame comprises a first special station info field and a second special station info field, and the second special station info field carrying one or more of: a recommended channel state information (CSI) ultra-high reliability (UHR) modulation and coding scheme (MCS) level field; a CSI target receive power field; or an AP transmit power field.

According to some embodiments, the values of the recommended CSI UHR MCS level field are set according to a worst-case scenario across overlapping basic service set (OBSS) stations.

According to some embodiments, the recommended CSI UHR MCS level field is 5 bits and located at bit B20-B24 in the second special station info field.

According to some embodiments, value 31 of the recommended CSI UHR MCS level field designating no recommendation.

According to some embodiments, the method further comprises: transmitting, by the first AP a first frame comprising coordinated sounding control information, wherein the coordinated sounding control information comprises the recommended CSI UHR MCS level field; and receiving, by the first AP, a CSI report frame with a MCS level set by the STA according to the coordinated sounding control information in the first frame, wherein the first frame comprises a beamforming report poll (BFRP).

According to some embodiments, the method further comprises: setting the recommended CSI UHR MCS level value to 31 during an initial coordinated beamforming sounding process; and/or updating the recommended CSI UHR MCS level values based on overheard OBSS CSI reports from nearby non-AP stations.

According to some embodiments, the first AP is a sharing AP and the second AP is a shared AP, or the first AP is a shared AP and the second AP is a sharing AP.

According to some embodiments, a communication method comprises: receiving, by a station (STA) from access point (AP), a first frame comprising coordinated sounding control information, wherein the coordinated sounding control information comprises a recommended CSI UHR MCS level field; and transmitting, by the station to the AP, a CSI report frame with a MCS level set by the STA according to the coordinated sounding control information in the first frame, wherein the first frame comprises a beamforming report poll (BFRP).

According to some embodiments, the AP is a sharing AP or a shared AP.

According to some embodiments, an apparatus comprises: one or more processors couple with a memory storing instructions which, when executed by the one or more processors, cause the apparatus to perform a method, the method comprising: transmitting, from a first AP to a second AP, a first Null-Data PPDU Announcement (NDPA) frame comprising first sounding control information; and/or receiving, from the second AP to the first AP, a second NDPA frame comprising second sounding control information, wherein the first NDPA frame or the second NDPA frame comprises a first special station info field and a second special station info field, and the second special station info field carrying one or more of: a recommended channel state information (CSI) ultra-high reliability (UHR) modulation and coding scheme (MCS) level field; a CSI target receive power field; or an AP transmit power field.

According to some embodiments, the values of the recommended CSI UHR MCS level field are set according to a worst-case scenario across overlapping basic service set (OBSS) stations.

According to some embodiments, the recommended CSI UHR MCS level field is 5 bits and located at bit B20-B24 in the second special station info field.

According to some embodiments, value 31 of the recommended CSI UHR MCS level field designating no recommendation.

According to some embodiments, the method further comprises: transmitting, by the first AP a first frame comprising coordinated sounding control information, wherein the coordinated sounding control information comprises the recommended CSI UHR MCS level field; and receiving, by the first AP, a CSI report frame with a MCS level set by the STA according to the coordinated sounding control information in the first frame, wherein the first frame comprises a beamforming report poll (BFRP).

According to some embodiments, the method further comprises: setting the recommended CSI UHR MCS level value to 31 during an initial coordinated beamforming sounding process; and/or updating the recommended CSI UHR MCS level values based on overheard OBSS CSI reports from nearby non-AP stations.

According to some embodiments, the first AP is a sharing AP and the second AP is a shared AP, or the first AP is a shared AP and the second AP is a sharing AP.

According to some embodiments, an apparatus comprises: one or more processors couple with a memory storing instructions which, when executed by the one or more processors, cause the apparatus to perform a method, the method comprising: receiving, by a station (STA) from access point (AP), a first frame comprising coordinated sounding control information, wherein the coordinated sounding control information comprises a recommended CSI UHR MCS level field; and transmitting, by the station to the AP, a CSI report frame with a MCS level set by the STA according to the coordinated sounding control information in the first frame, wherein the first frame comprises a beamforming report poll (BFRP).

According to some embodiments, the AP is a sharing AP or a shared AP.

### BRIEF DESCRIPTION OF FIGURES

FIG. 1 schematically illustrates a basic service Set (BSS) based multi-AP environment.

FIG. 2 is a schematic diagram of a device that may perform any or all operations of the above methods and features explicitly or implicitly described herein, according to different embodiments of the present disclosure.

FIG. 3 is a definition of a new subtype of Ranging trigger frame to create a Coordinated Sounding or Coordinated Beamforming Initial Control Frame (ICF) according to an embodiment of the present disclosure.

FIG. 4A is a definition of a User Info Field of the Ranging trigger frame-based Coordinated Sounding or Coordinated Beamforming ICF in the single sounding case according to an embodiment of the present disclosure.

FIG. 4B is a definition of a User Info Field of the Ranging trigger frame-based Coordinated Sounding or Coordinated Beamforming ICF in the multiple sounding case according to an embodiment of the present disclosure.

FIG. 5 is a definition of a new Trigger Type of trigger frame to create an alternate Coordinated Sounding or Coordinated Beamforming Initial Control Frame (ICF) according to another embodiment of the present disclosure.

FIG. 6A is a definition of a User Info Field of the new Coordinated Sounding or Coordinated Beamforming ICF trigger type frame in the single sounding case according to an embodiment of the present disclosure.

FIG. 6B is a definition of a User Info Field of the new Coordinated Sounding or Coordinated Beamforming ICF trigger type frame in the multiple sounding case according to an embodiment of the present disclosure.

FIG. 7 is a definition of a new subtype of MultiUser BlockAck Request (MU-BAR) trigger frame to create another alternate Coordinated Sounding or Coordinated Beamforming Initial Control Frame (ICF) according to a further embodiment of the present disclosure.

FIG. 8A is a definition of a User Info Field of the MU-BAR trigger frame-based Coordinated Sounding or Coordinated Beamforming ICF in the single sounding case according to an embodiment of the present disclosure.

FIG. 8B is a definition of a User Info Field of the MU-BAR trigger frame-based Coordinated Sounding or Coordinated Beamforming ICF in the multiple sounding case according to an embodiment of the present disclosure.

FIG. 9 is a definition of a new subtype of Buffer Status Report Poll (BSRP) trigger frame to create a third alternate Coordinated Sounding or Coordinated Beamforming Initial Control Frame (ICR) according to a further embodiment of the present disclosure.

FIG. 10A is a general format of an ICF Info Field with a dedicated AID12 to add to the BSRP trigger frame, according to an embodiment of the present disclosure.

FIG. 10B is a specific format of an ICF Info Field when the ICF Type is set to Co-BF ICF.

FIG. 10C is a format of a User Info Field of the BSRP trigger frame-based Coordinated Sounding or Coordinated Beamforming ICF in the multiple sounding case according to an embodiment of the present disclosure.

FIG. 11 is a definition of UHR variant Common Info subfields common to all abovementioned ICF trigger frame formats according to an embodiment of the present disclosure.

FIG. 12 is a definition of Special User Info Field subfields common to all abovementioned ICF trigger frame formats according to an embodiment of the present disclosure.

FIG. 13 is a definition of a Block Ack-based Coordinated Beamforming (Co-BF) Initial Control Response (ICR) frame, according to an embodiment of the present disclosure.

FIG. 14 is a definition of an Association ID Traffic ID (AID TID) subfield of a Block Ack information record of a Co-BF ICR frame according to an embodiment of the present disclosure.

FIG. 15 is a table of values of the AID TID subfield and their possible interpretations according to embodiments of the present disclosure according to an embodiment of the present disclosure.

FIG. 16 illustrates a possible combination of Ack Type and TID subfield value to indicate conveyance of other control info, according to an embodiment of the present disclosure.

FIG. 17 is a detailed breakdown of the use of the Block Ack information Per AID TID info record to represent Coordinated Beamforming necessary parameters according to an embodiment of the present disclosure.

FIG. 18 is an example joint sounding sequence showing a joint sounding process.

FIG. 19 is an example sequential sounding sequence showing a sequential sounding process.

FIG. 20 is a definition of a new subtype of Buffer Status Report Poll (BSRP) trigger frame to create a Coordinated Sounding Initial Control Frame (ICR) according to an embodiment of the present disclosure.

FIG. 21 is a specific format of an ICF Info Field when the ICF Type is set to Co-BF sounding ICF.

FIG. 22 is a format of a User Info Field of the BSRP trigger frame-based Coordinated Sounding ICF according to an embodiment of the present disclosure.

FIG. 23 is a format of a Special STA Info field in the NDP Announcement frame with EHT variant indication according to an embodiment of the present disclosure.

FIG. 24 is a detailed breakdown of the use of the Block Ack information Per AID TID info record to represent Coordinated Sounding necessary parameters according to an embodiment of the present disclosure.

FIG. 25 is another specific format of an ICF Info Field when the ICF Type is set to Co-BF sounding ICF.

FIG. 26 is a format of a User Info Field of the BSRP trigger frame-based Coordinated Sounding ICF according to another embodiment of the present disclosure.

FIG. 27 is a format of an alternate Special STA Info field in the NDP Announcement frame with EHT variant indication according to an embodiment of the present disclosure.

FIG. 28 is a format of another alternate Special STA Info field in the NDP Announcement frame with EHT variant indication according to an embodiment of the present disclosure.

FIG. 29A is a format of a third alternate Special STA Info field in the NDP Announcement frame with EHT variant indication according to an embodiment of the present disclosure.

FIG. 29B is a format of a fourth alternate Special STA Info field in the NDP Announcement frame with EHT variant indication according to an embodiment of the present disclosure.

FIG. 30A is an example sequential sounding sequence showing information included in a BFRP transmitted by the Sharing AP or a shared AP in a sequential sounding process.

FIG. 30B is another example sequential sounding sequence showing information included in a BFRP transmitted by the Sharing AP or a shared AP in a sequential sounding process.

FIG. 31 is a format of a fifth alternate Special STA Info field in the NDP Announcement frame with EHT variant indication according to an embodiment of the present disclosure.

FIG. 32 is a format of a sixth alternate Special STA Info field in the NDP Announcement frame with EHT variant indication according to an embodiment of the present disclosure.

FIG. 33 is a format of an AID Range Negotiation Element according to an embodiment of the present disclosure.

FIG. 34 is a table of Public Action field values with a new value allocated to indicate a Multi-AP AID Range Negotiation Action Frame, according to an embodiment of the present disclosure.

FIG. 35 is a list of fields contained in the Multi-AP AID Range Negotiation Action Frame format, according to an embodiment of the present disclosure.

### DETAILED DESCRIPTION

A wireless communications system to which embodiments of the present disclosure are applicable may be a wireless local area network (wireless local area network, WLAN) device, referred to as a station (STA). Such a STA may be a mobile STA, but that is not a requirement. For example, as will be apparent, embodiments of the disclosure are applicable for fixed STAs or APs. The communications device may be a wireless communications device that supports other wireless protocols.

Multi-AP collaboration schemes have been discussed as main candidate features for adoption in wireless LAN (WLAN) 802.11 standards. Enabling some degree of coordination among neighboring APs permits more efficient utilization of limited wireless resources, such as time, frequency, power, and spatial resources. Additionally, enabling information sharing among coordinated APs (i.e., user scheduling and channel quality information) can ameliorate co-channel interference which can become unbearable in increasingly densified wireless networks. Therefore, embodiments allow for multi-AP coordination which can turn the interfering APs into collaborative sounding and beamforming participants for STAs located at overlapped basic service sets (BSSs). Throughout the instant application, Multi-AP collaboration is to be construed as APs functioning together to achieve a common communication goal such as sounding, beamforming, or a coordinated transmission. Multi-AP Coordination is to be construed as APs functioning independently in an overlapping setting to achieve separate communication goals while actively avoiding interfering with one another. While spatial reuse and channel puncturing are examples of means to achieve Multi-AP Coordination through reduction of interference, Coordinated beamforming is a means to achieving Multi-AP Collaboration through synergy, rather than mere noninterference, of multiple APs.

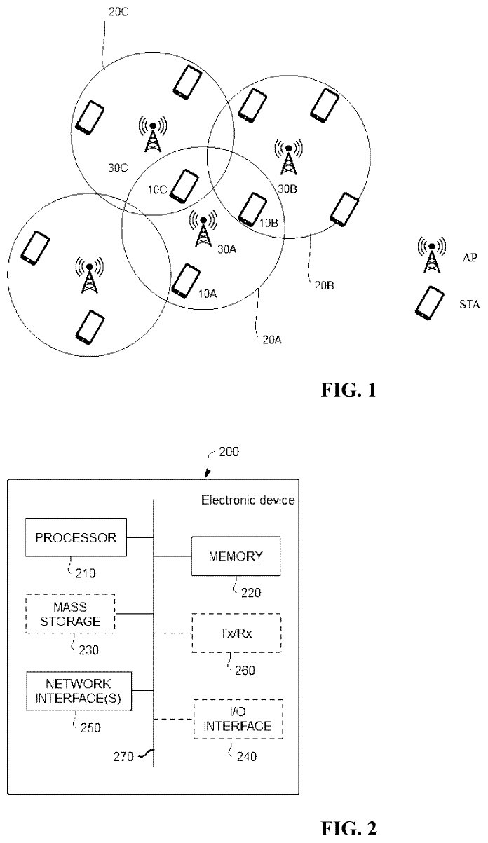

FIG. 1 schematically illustrates a basic service set (BSS) based environment. Each BSS 20 is served by an AP 30. Accordingly BSS 20A is served by AP 30A, BSS 20B is served by AP 30B, and BSS 20C is served by AP 30C. As can be seen STA 10A is within BSS 20A, whereas STA 10B is within both BSS 20A and BSS 20B, and STA 10C is within both BSS 20C and BSS 20A. STA 10A, being within BSS 20A, would be served by (or associated with) AP 30A. STA 10B being within both BSS 20A and BSS 20B, could be served by AP 30A or 30B. However, if STA 10B is served by AP 30A, it may receive co-channel interference from AP 30B. Coordinated sounding and beamforming is a proposed solution so such co-channel interference.

Disclosed in the present application are a Coordinated Beamforming Initial Control Frame (ICF) and Initial Control Response (ICR) frame and communication methods using the same. In an embodiment, when an AP in control of one overlapping BSS such as AP 30A in FIG. 1 obtains the Transmission Opportunity (TXOP) to access the wireless medium, it initiates coordinated beamforming (Co-BF) by sending a Co-BF ICF to invite one or more shared APs 30B for coordinated sounding, beamforming and transmission. In the context of this disclosure, the Sharing AP is the AP which will invite other APs to participate in sounding, beamforming and transmission in the TXOP. The Shared APs are one or more other APs which are invited to participate in sounding, beamforming and transmission.

Through this Co-BF ICF, the sharing AP shares coordinated sounding information with the shared AP, including:
Bandwidth (BW) and punctured channel information.
Number of Long Training Fields (NLTF) in Null Data Packet (NDP) (P-matrix size).
Starting stream index and number of spatial streams (NSS) for shared AP in NDP.
Guard Interval (GI) and UHR LTF Type.
TXOP duration.
Tx Error Vector Magnitude (EVM) related information which may be needed for coordinated sounding.

The sharing AP also communicates the Co-BF instance ID and may optionally specify the non-AP STAs it plans to serve within this TXOP with the shared AP.

Two cases may occur during the Co-BF sounding and transmission phases.

In a first case, the single-sounding case, one sounding process is allowed per TXOP. In this case, the Co-BF ICF trigger frame enables the Sharing AP to initiate the Co-BF sounding and transmission phases with the Shared AP(s). The Sharing AP also uses the Co-BF ICF to communicate the MAP agreement ID, Co-BF instance ID, specify the non-AP STAs it plans to serve within this TXOP with the Shared AP, and share other common control information. Here, the list of STAs to be served remains fixed for the duration of the TXOP.

In a second case, the multiple-sounding case, multiple sounding processes are allowed per TXOP. Here, the Co-BF ICF trigger frame again enables the Sharing AP to initiate Co-BF sounding and transmission phases with the Shared AP(s). The Sharing AP uses the Co-BF ICF to communicate the MAP agreement ID, Co-BF instance ID, and other common control information. Unlike Case 1, there is no need to declare the STAs to be served, as they can vary with each transmission within the TXOP.

In a further step of the method, the shared AP responds to the ICF by transmitting an ICR, received by the sharing AP, to acknowledge the shared AP's ability to participate in the Co-BF transmission during shared TXOP, and in case of a single-sounding TXOP, declares the non-AP STAs it will serve.

Further details of the design features of the Co-BF ICF and ICR frames are now disclosed. The ICF and ICR frames utilize trigger frame and trigger-based formats, respectively, similar to those existing in 802.11 in order to solicit trigger-based acknowledgment of participation in Co-BF and coordinated sounding. The main purpose of the Co-BF ICF trigger frame is to enable the Sharing AP to initiate the Co-BF sounding and transmission phases with the Shared AP(s). Additionally, the sharing AP uses the Co-BF ICF to communicate with the shared AP the MAP agreement ID, Co-BF instance ID, optionally specifies the non-AP STAs it plans to serve within the TXOP only if the TXOP is single-sounding, and other TBD control info.

All 802.11 trigger frames contain a Common Info Field with a Trigger Type subfield specifying what kind of process is being triggered. The Co-BF ICF frame may utilize any appropriate frame type, such as a ranging trigger frame e.g., by setting the Trigger Type subfield value to ‘8’ in the UHR variant Common Info field), a multi-user block acknowledgement request (MU-BAR) trigger frame (e.g., by setting the Trigger Type subfield value to ‘2’), as a multi-user request-to-send (MU-RTS) trigger frame (e.g., by setting the Trigger Type subfield value to ‘3’), or a buffer status report poll (BSRP) trigger frame (e.g., by setting the Trigger Type subfield value to ‘4’).

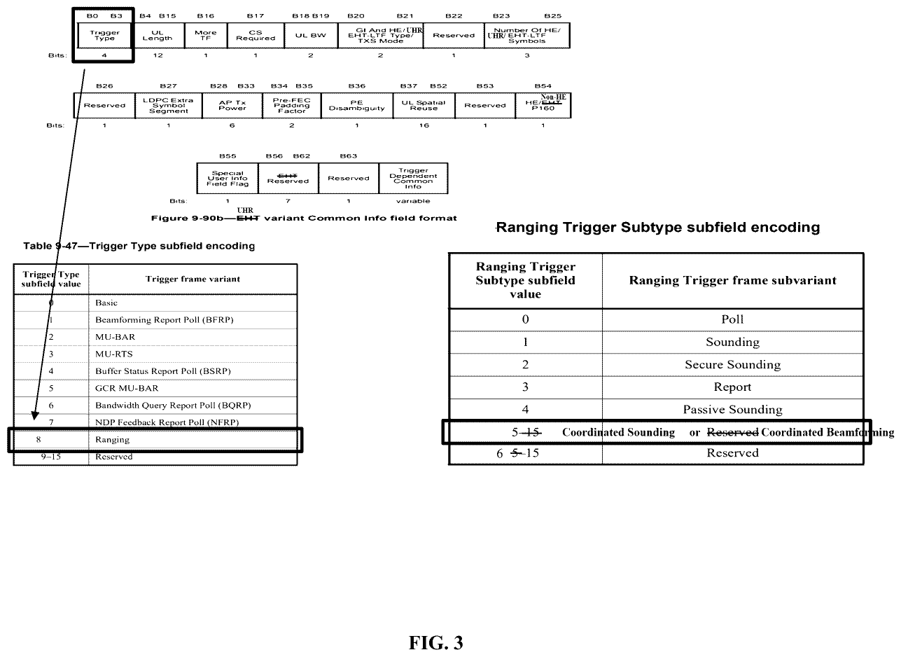

In some embodiments, a new trigger frame variant may be defined as a Co-BF ICF, without reusing an existing variant, based on setting the value of the Trigger Type subfield to indicate a reserved value (e.g., a value selected from the range 9 to 15). Several types of possible ICF formats are depicted in FIGS. 3 to 8 as further explained below.

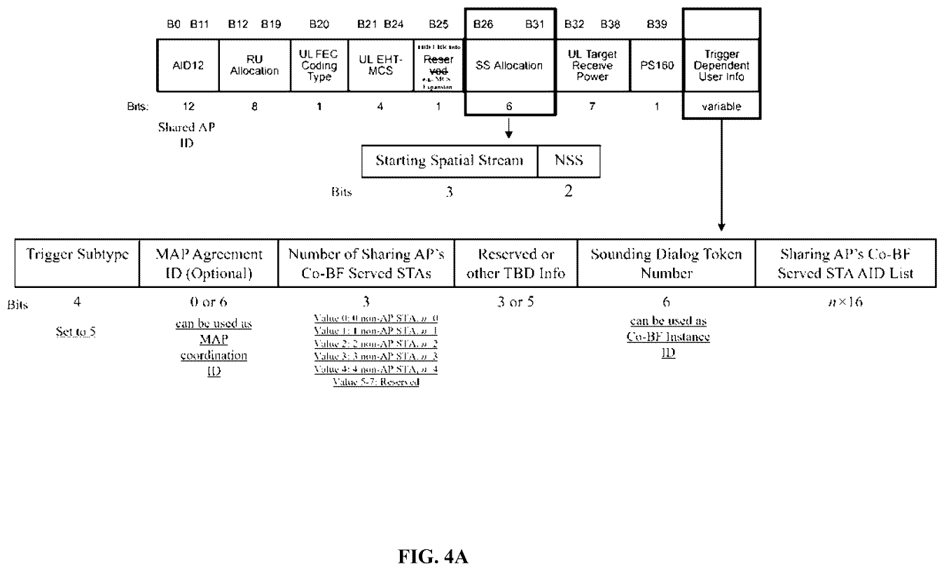

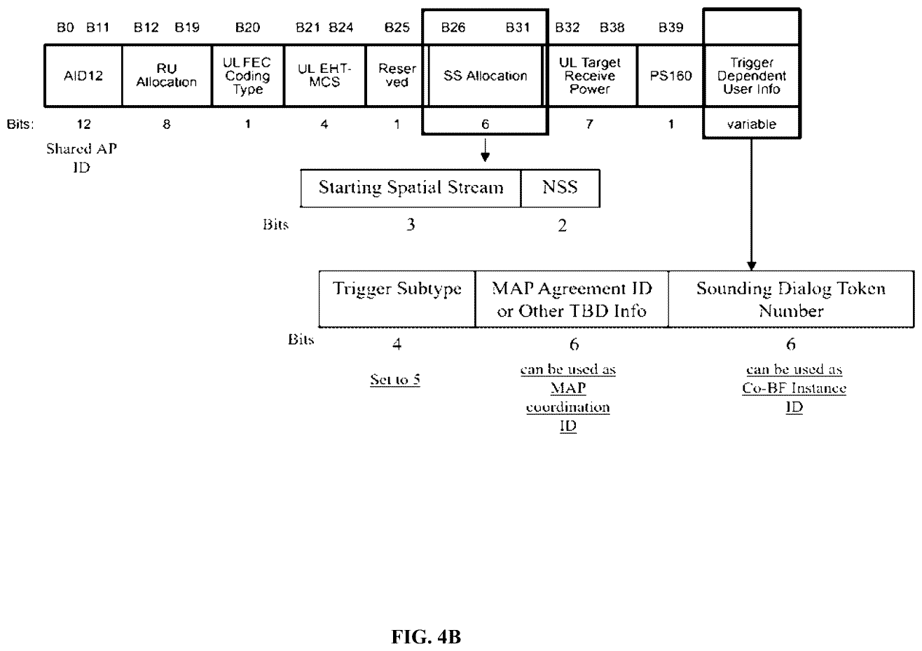

In a first embodiment of the Initial Control Frame, referring to FIGS. 3, 4A, and 4B, the instant application discloses using the ranging trigger frame as a Co-BF ICF by setting the trigger type subfield in the UHR variant Common Info subfield to a value of 8. Additionally, one of the reserved values (e.g., 5-15) in the Ranging Subtype subfield of the Trigger-Dependent User Info field within the Ranging trigger frame is repurposed to indicate the MAP-coordinated Sounding or Coordinated Beamforming trigger frame, effectively designating it as a Co-BF ICF, as illustrated in FIG. 3.

Regarding the design of the User Info field of the Coordinated Sounding or Coordinated Beamforming trigger frame, it will be as depicted in FIG. 4A in the case of a single-sounding TXOP, including a number of STAs to be served and their STA AIDs, or it will be as depicted in FIG. 4B in the case of a multiple-sounding TXOP, not including the number of STAs to be served or their STA AIDs.

Regarding the design of the User Info field of the Coordinated Sounding or Coordinated Beamforming trigger frame, it will be as depicted in FIG. 4A in the case of a Co-BF transmission, including a number of STAs to be served and their STA AIDs, or it will be as depicted in FIG. 4B in the case of a multiple-sounding TXOP, not including the number of STAs to be served or their STA AIDs.

Within the User Info field of the Coordinated Sounding or Coordinated Beamforming trigger frame, the AID12 field is set to include the Shared AP ID. This Shared AP ID is assigned by the Sharing AP to the Shared AP during the MAP coordination agreement negotiation phase. The SS Allocation field may be formatted to include 3-bit Starting Spatial Stream subfield and 2-bit Number of Spatial Streams (NSS) subfield. Since the NSS per user may be defined to 4 streams, 2 bits may be enough for the NSS subfield. However, 3-bit Number of Spatial Streams (NSS) subfield is also possible.

For the Trigger Dependent User Info, the trigger subtype subfield may be set to one of the reserved values (e.g., 5-15) to indicate that this trigger frame will be used as a Co-BF ICF frame. This Trigger Dependent User Info will also include the necessary information to be shared with the Shared AP for Co-BF transmission phase, particularly for the coordinated sounding process. This includes the MAP Agreement ID, the number of non-AP STAs to be served (in a single-sounding TXOP only, otherwise this subfield is skipped) by the Sharing AP during the Co-BF shared TXOP, the Sounding Dialog Token Number repurposed as the Co-BF Instance ID, and a list of non-AP STAs the Sharing AP will serve (in a single-sounding TXOP only, otherwise this subfield is skipped) during the Co-BF shared TXOP, as well as other control information as shown in FIG. 4A (single-sounding) and FIG. 4B (multiple-sounding).

A positive acknowledgement by ICR constitutes an agreement for multi-AP collaboration, that is, coordinated sounding and/or beamforming. The MAP Agreement ID is used by any AP when exchanging management or control frames between any subset of APs that are members of this agreement, for instance in the ICF/ICR used to complete the setting of agreement parameters for shared AP(s) in a particular TXOP (or part of thereof).

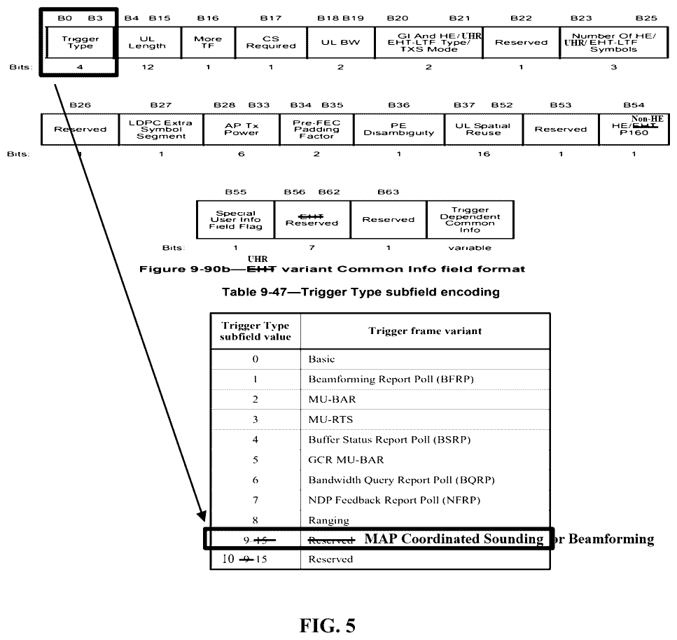

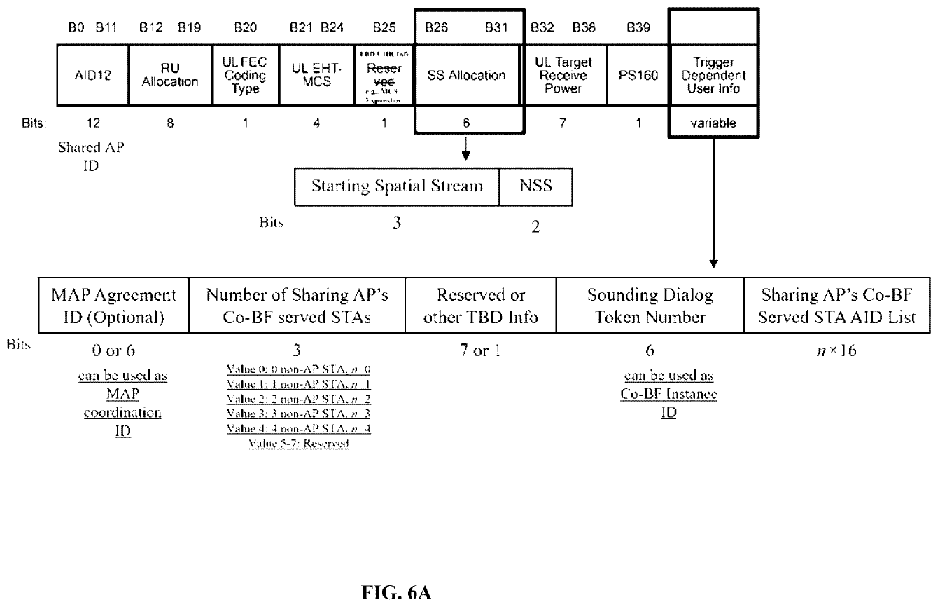

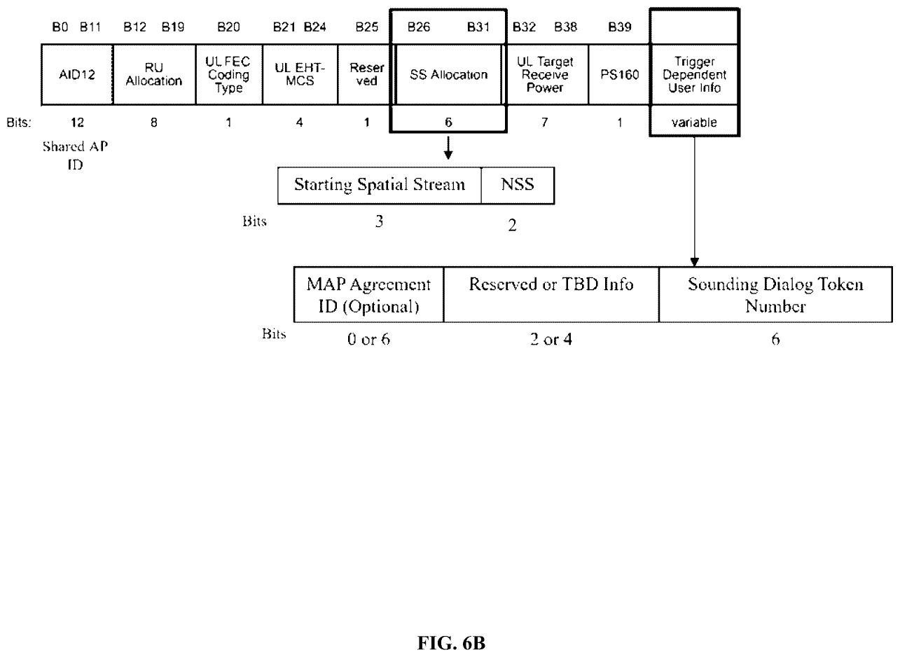

A second embodiment of the Initial Control Frame is now described, with reference to FIGS. 5, 6A, and 6B. Disclosed is a new trigger frame type definition to be used for the Co-BF ICF by setting the trigger type subfield in the UHR variant Common Info subfield to one of the reserved values (e.g., 9-15). For instance, the reserved value 9 is repurposed to indicate MAP coordinated sounding or beamforming as shown in FIG. 5.

Regarding the design of the User Info field of the Coordinated Sounding or Coordinated Beamforming trigger frame, it will be as according to FIG. 6A in the case of a single-sounding TXOP, including a number of STAs to be served and their STA AIDs, or it will be as depicted in FIG. 6B in the case of a multiple-sounding TXOP, not including the number of STAs to be served or their STA AIDs. Within the User Info field of the Coordinated Sounding or Coordinated Beamforming trigger frame, the AID12 field may be set to include the Shared AP ID. This Shared AP ID is assigned by the Sharing AP to the Shared AP during the MAP coordination agreement negotiation phase. The SS Allocation field may be formatted to include 3-bit Starting Spatial Stream subfield and 2-bit Number of Spatial Streams (NSS) subfield.

For the Trigger Dependent User Info, this Trigger Dependent User Info also includes the necessary information to be shared with the Shared AP for Co-BF transmission phase, particularly for the coordinated sounding process. This includes the MAP Agreement ID, the number of non-AP STAs to be served (in a single-sounding TXOP only, otherwise this subfield is skipped) by the Sharing AP during the Co-BF shared TXOP, the Sounding Dialog Token Number repurposed as the Co-BF Instance ID, and a list of non-AP STAs the Sharing AP will serve (in a single-sounding TXOP only, otherwise this subfield is skipped) during the Co-BF shared TXOP, as well as other control information as shown in FIGS. 6A and 6B.

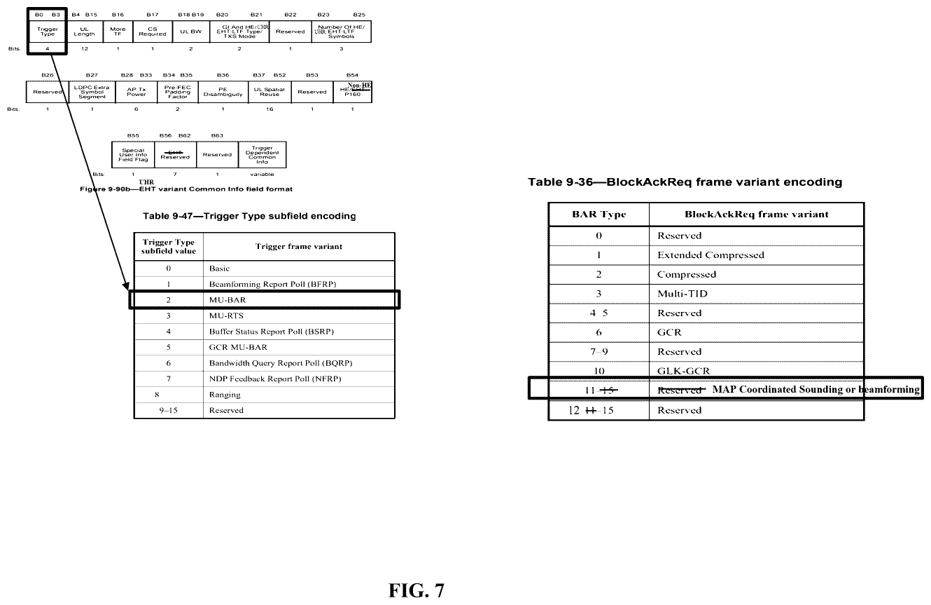

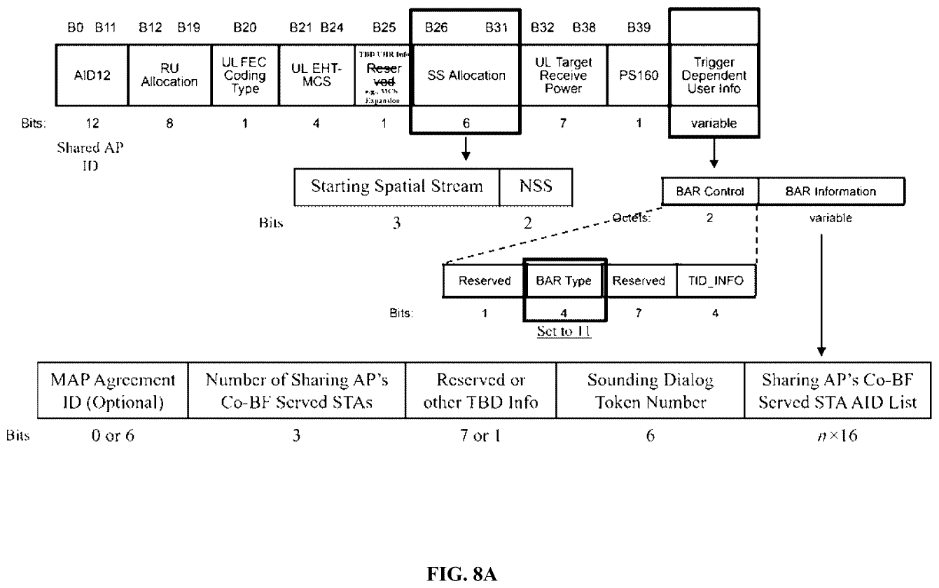

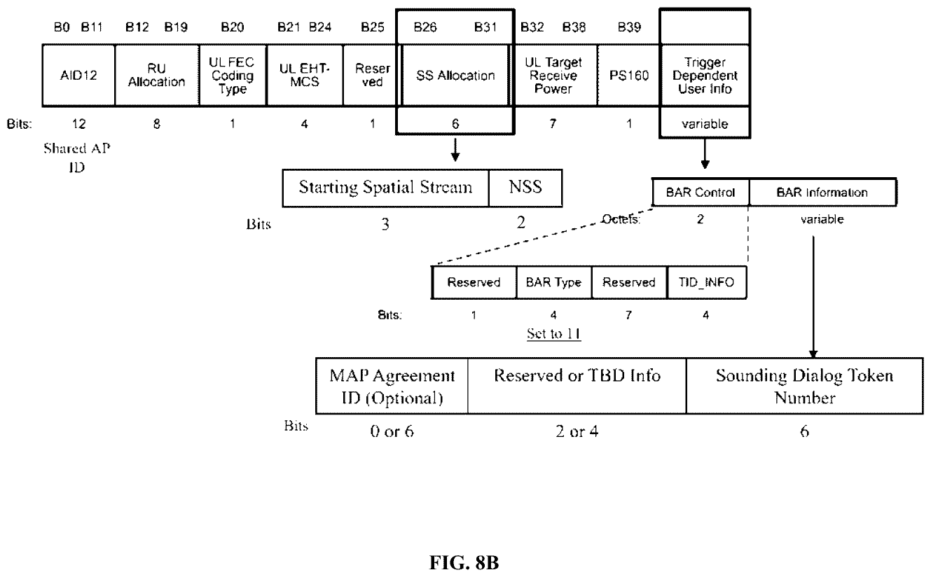

With reference to FIGS. 7, 8A and 8B, the instant application discloses a third embodiment of the ICF frame, that is using the MU-BAR trigger frame as a Co-BF ICF by setting the trigger type subfield in the UHR variant Common Info subfield to a value of 2. Additionally, one of the reserved values (4-5, 7-9, or 11-15) is repurposed in the BAR Type subfield in the BAR Control of the Trigger-Dependent User Info field within the MU-BAR trigger frame to indicate the MAP-coordinated Sounding or Coordinated Beamforming trigger frame, effectively designating it as a Co-BF ICF, as illustrated in FIG. 7.

The Co-BF parameters may be indicated via the Trigger Dependent User Info field of the MU-BAR trigger frame. The Trigger Dependent User Info subfield format of the MU-BAR trigger frame includes a block acknowledgement request (BAR) Control subfield and a BAR Information subfield. The BAR Control field includes one or more subfields including a BAR Type subfield, and a reserved subfield. In this embodiment the BAR Type subfield may indicate that the trigger frame is a Co-BF ICF.

The BAR Type subfield usually indicates a BlockAckReq frame variant. One of the reserved values (4-5, 7-9, or 11-15) can be used to indicate, via the BAR Type subfield, a frame variant for Co-BF purposes. FIG. 7 illustrates an updated encoding for the BlockAckReq frame variant, according to this embodiment. As an example, a reserved value of 11 for BAR Type subfield can be used to indicate MAP Coordinated Sounding or Coordinated Beamforming as the BlockAckReq frame variant. It may be appreciated that other reserved values (4-5, 7-9, or 11-15) can also be similarly used.

Regarding the design of the User Info field of the Coordinated Sounding or Coordinated Beamforming trigger frame, it will be as illustrated in FIG. 8A in the case of a single-sounding TXOP, including a number of STAs to be served and their STA AIDs, or it will be as depicted in FIG. 8B in the case of a multiple-sounding TXOP, not including the number of STAs to be served or their STA AIDs. Within the User Info field of the Coordinated Sounding or Coordinated Beamforming trigger frame, the AID12 field is set to include the Shared AP ID. This Shared AP ID is assigned by the Sharing AP to the Shared AP during the MAP coordination agreement negotiation phase. The SS Allocation field may be formatted to include 3-bit Starting Spatial Stream subfield and 2-bit Number of Spatial Streams (NSS) subfield.

For the Trigger Dependent User Info, the BAR Type subfield may be set to one of the reserved values (e.g., 4-5, 7-9, or 11-15) to indicate that this trigger frame will be used as a Co-BF ICF frame. This Trigger Dependent User Info will also include the necessary information to be shared with the Shared AP for Co-BF transmission phase, particularly for the coordinated sounding process. This includes the MAP Agreement ID, the number of non-AP STAs to be served (in a single-sounding TXOP only, otherwise this subfield is skipped) by the Sharing AP during the Co-BF shared TXOP, the Sounding Dialog Token Number repurposed as the Co-BF Instance ID, and a list of non-AP STAs the Sharing AP will serve (in a single-sounding TXOP only, otherwise this subfield is skipped) during the Co-BF shared TXOP, as well as other control information as shown in FIGS. 8A and 8B.

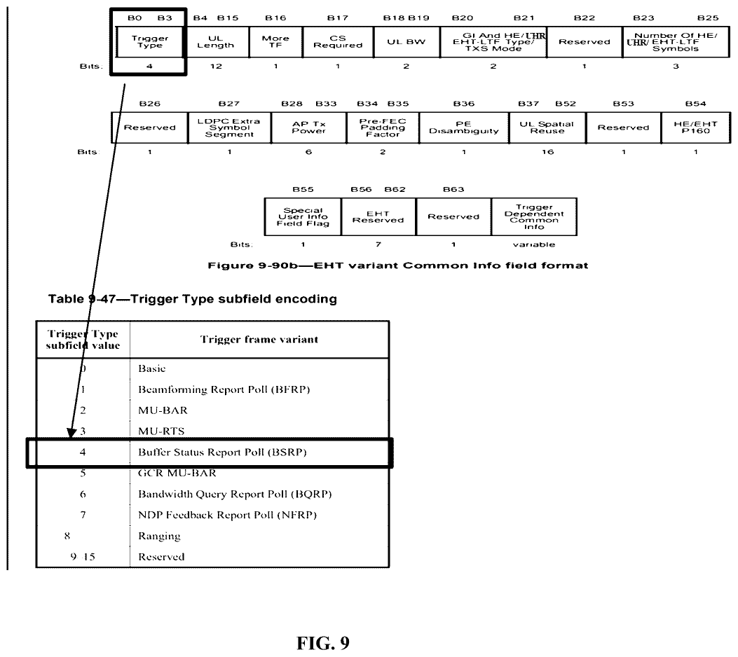

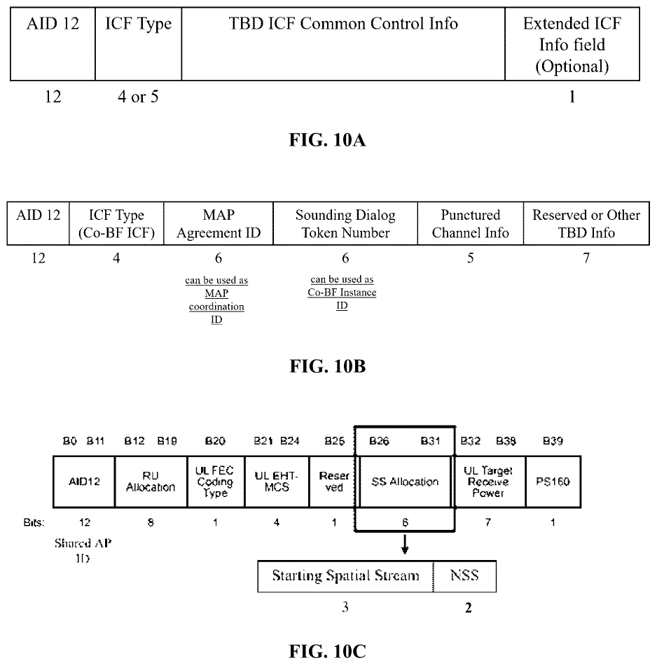

With reference to FIGS. 9, 10A, 10B, and 10C, the instant application discloses a fourth embodiment of the ICF frame, that is using the Buffer Status Report Poll (BSRP) trigger frame as a Co-BF ICF by setting the trigger type subfield in the UHR variant Common Info subfield to a value of 4, as illustrated in FIG. 9.

To create more space for ICF control information, a User Info field dedicated to ICF-type-specific information is added to the BSRP trigger frame, according to an embodiment of the present disclosure. A general format for this ICF info field is shown in FIG. 10A.

For the AID 12 field, a fixed value should be defined in the 802.11bn specification to identify this user info record as an ICF Info field. If this value falls within the range of 1-2006, the field will be placed immediately after the Special User Info field. If the value is greater than 2007, the field will be positioned following the User Info List.

For the ICF type, this field is used to specify the type of ICF, including options such as Coordinated Beamforming (Co-BF), Coordinated Spatial Reuse (Co-SR), Coordinated TDMA (Co-TDMA), Coordinated Restricted Target Wake Time (Co-r-TWT), In-device Coexistence (IDC), Dynamic Sub-Band Operation (DSO), Non-primary Channel Access (NPCA), Dynamic Power Save (DPS), and other types to be determined (TBD).

Because the need may arise to extend this field to accommodate more info, one bit is used as an indication flag for the presence of an extended ICF Info field.

To use this general ICF Info format as a Co-BF ICF, a specific value of ICF type, for instance any unallocated value from 0 to 15, namely 0 or 1, is allocated to Co-BF ICF. With the ICF type set to the Co-BF ICF value, the format of the ICF Info Field takes on the format shown in FIG. 10B with 6 bits allotted to MAP Agreement ID, 6 bits allotted to Co-BF Instance ID, and 5 bits allotted to Punctured Channel Info.

Regarding the Punctured Channel Info, it can be formatted in 5 bits, as in IEEE 802.11be-2024. Table 36-30-Definition of the Punctured Channel Information field in the U-SIG for an EHT MU PPDU using non-OFDMA transmissions. The contents of this table are incorporated herein by reference.

The regular User Info Field for the BSRP trigger frame, for all other AID12 that are not specially allocated, is formatted according to FIG. 10C.

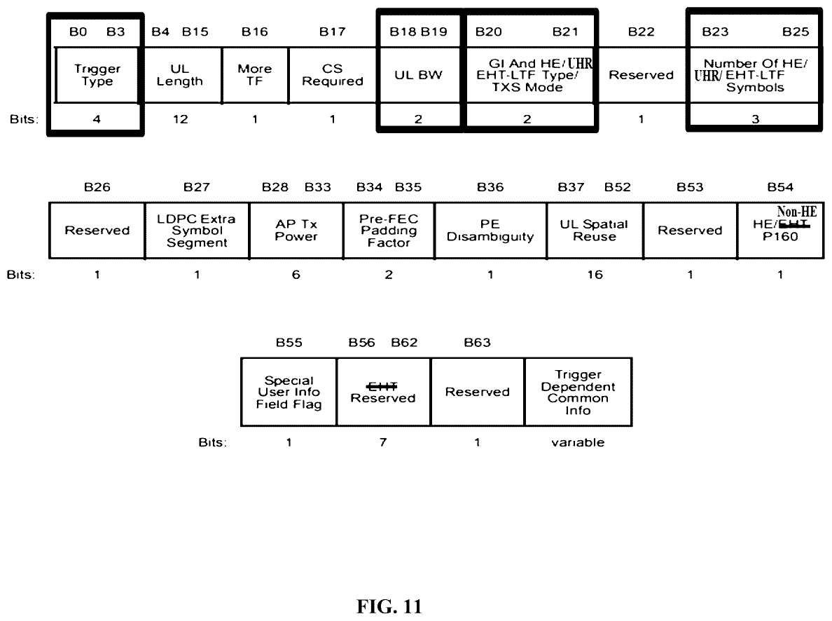

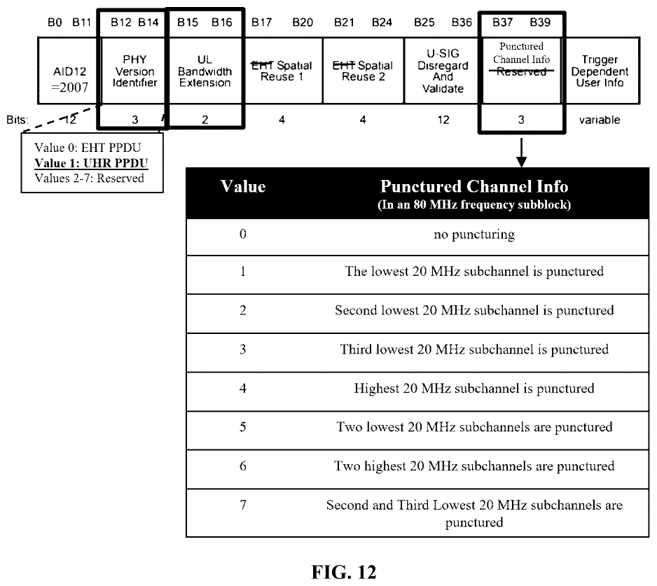

Whether the ICF utilizes a ranging trigger frame as in the first embodiment, a new heretofore unused trigger type as in the second embodiment, a MU-BAR trigger frame type as in the third embodiment, a BSRP trigger frame as in the fourth embodiment, or another existing trigger frame type not shown here, other Co-BF Common Control Info can be indicated in the UHR variant Common Info field and UHR variant Special User Info field in the following manner according to an embodiment of the present disclosure, also depicted in FIG. 11.
The UL BW field in the UHR variant Common Info field (FIG. 11) combined with the UL Bandwidth Extension in the UHR variant Special User Info field (FIG. 12) are used to provide the bandwidth info for the shared AP.
The GI And UHR-LTF Type and Number of UHR LTF are included in the UHR variant Common Info field.
With reference to FIG. 12, the value of the PHY Version Identifier of the UHR Variant of the Special User Info field is also set to 1 to indicate a UHR PPDU is being solicited.
Regarding the Punctured Channel Info (except in the case of the BSRP-based ICF frame, where punctured channel info is in the dedicated-AID ICF Info Field), the instant application proposes to repurpose the 3 reserved bits (B37-B39) in the Special User Info field to indicate the Punctured Channel Info. The encoding of the 3-bit subfield is as indicated in the table included in FIG. 12.
Another way, the Punctured Channel Info can also be formatted in 5 bits, as in Table 36-30-Definition of the Punctured Channel Information field in the U-SIG for an EHT MU PPDU using non-OFDMA transmissions [2]. In this case, the ICF can utilize any 5 reserved values in the UHR Common Info field or the 5 bits within the U-SIG Disregard And Validate subfield in the UHR Variant Special User Info field to represent the Punctured Channel Information field in 5 bits.

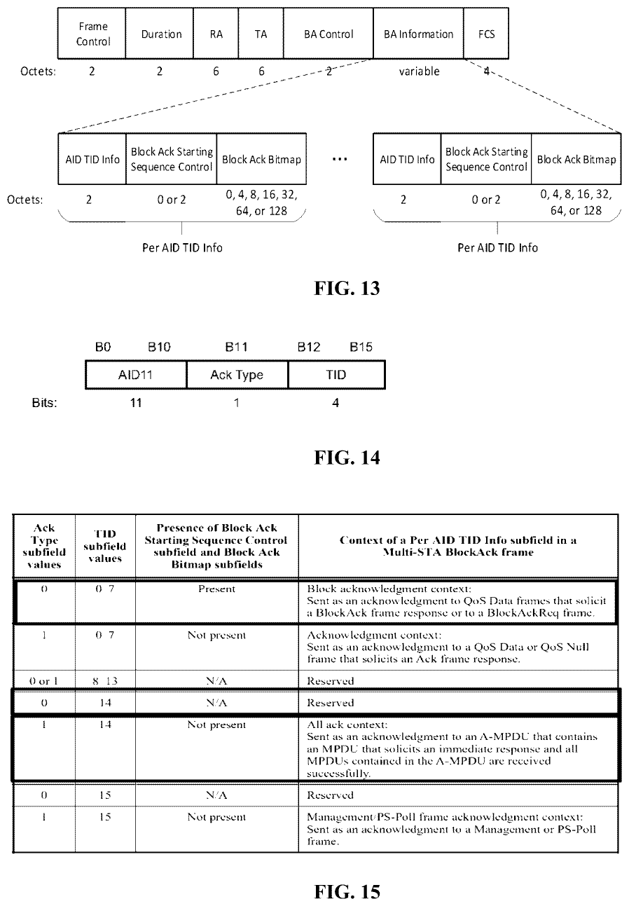

The solicited response to a Co-BF ICR trigger frame is a Co-BF Initial Control Response (ICR) trigger-based frame. According to the present disclosure, a first embodiment of the Co-BF (ICR) is disclosed. The main purpose of the Co-BF ICR trigger-based frame is to enable the Shared AP to acknowledge its ability to participate in the Co-BF transmission with the Shared AP during the shared TXOP and declare the non-AP STAs it will serve (in case of a single-sounding TXOP) and other TBD control info. It will be appreciated that the Multi-STA BlockAck frame has a technical advantage when being used for an ICR since it allows for multiple “Per AID TID Info” fields to be included in the “BA Information” field, which finds particular use in a single-sounding TXOP. In this disclosure, it is proposed to design the Co-BF ICR frame based on a multi-STA BlockAck (BA) frame. From the BlockAck frame on which it is based, the Co-BF ICR frame inherits the MAC Frame Type of 1 for a control frame and the subtype of 9 for a BlockAck frame. FIG. 13 illustrates a Co-BF ICR frame, according to an embodiment.

The Shared AP includes up to two “Per AID TID Info” fields within the Multi-STA BA frame, sent to the Sharing AP: one Per AID TID Info field to acknowledge its ability, with an indication of readiness, to participate in the Co-BF transmission during shared TXOP, and one optional Per AID TID Info field to declare its associated non-AP STAs it will serve in a single-sounding TXOP, and other control info.

Each Per AID TID Info field includes an AID TID info subfield, a Block Ack Starting Sequence Control subfield and a Block Ack Bitmap subfield. Each “Per AID TID Info” field can be further subdivided as follows:
An AID TID Info subfield format contains the following subfields as illustrated in FIG. 14:
   a. 11 bits to indicate the AID
   b. 1 bit for Ack Type
   c. 4 bits for TID

According to the IEEE 802.11 standard, the AID 11 subfield carries the 11 least significant bits (LSBs) of the AID of the AP/non-AP STA for which the Per AID TID Info subfield is intended. The format of the Per AID TID Info subfield depends on the value of the AID11 subfield. If the Multi-STA BA frame is sent to an AP, the AID11 subfield is set to 0. A value of 2045 in the AID11 subfield is used as an identifier for any unassociated STA. If the AID11 subfield is set to 2045, then the ACK Type subfield and TID subfield are set to 0 and 15, respectively.

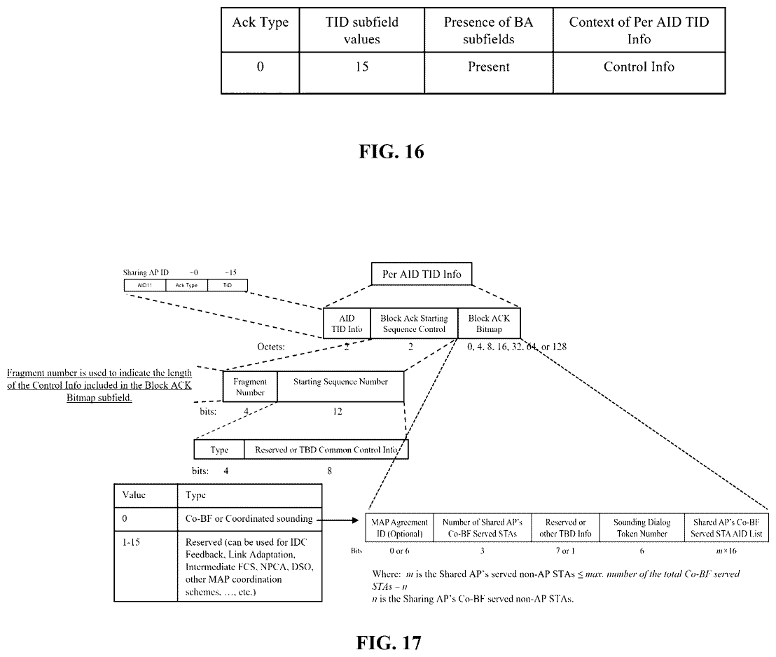

The value of the 1 bit ACK Type and 4 bits TID combined are used to indicate if this Per AID TID Info is sent for Ack, BA, or other control info, according to FIG. 15:
Regarding the one Per TID Info field that will be used to ACK the Co-BF MU-BAR ICF, it may have the same format as ACK=0 and TID=0-7.
Regarding the one Per TID Info field that will be used to ACK the new type or ranging Co-BF ICF, it can have the same format as ACK=1 and TID=14 or ACK=1 and TID=15.
Alternately, one of the reserved values can be utilized to ACK the receiving of any ICF in general, e.g. ACK=0 and TID=14.
One reserved value can be repurposed to indicate the intended use of the “Per AID TID Info” field: for conveying other control info, e.g. (Co-BF, In-Device Coexistence (IDC), Link Adaptation, MAP coordination, Intermediate FCS, Non-Primary Channel Access (NPCA), Dynamic Sub-band Operation (DSO), . . . , etc.), as presented in FIG. 16.

In further addressing the contents of the “Per AID TID Info” field, reference is made to FIG. 17.
The Block ACK Starting Sequence Control subfield is repurposed to contain metadata about Co-BF control info in the Fragment Number and Starting Sequence Number subfields.
   a. Fragment Number subfield is known to indicate the length of the BlockAck Bitmap, but is repurposed to indicate the length of the control info included in the Block Ack bitmap subfield.
   b. Starting Sequence Number is known to indicate the starting sequence number, but in embodiments the first 4 bits are used to indicate the type of control info, for instance:
      i. Value 0: indicates Co-BF ICR or Coordinated sounding.
      ii. Values 1-15: Reserved for other control info, In-Device Coexistence (IDC), Link Adaptation, MAP coordination, Intermediate FCS, Non-Primary Channel Access (NPCA), Dynamic Sub-band Operation (DSO), among other types of control information.
   The presence of Co-BF ICR and other TBD control info may be indicated by any allocated value of the type subfield within a range of 0-15.
      iii. The remaining 8 bits may be reserved for Common Control Info or other future use.
The Block ACK Bitmap subfield may be used to indicate the info parameters including MAP Agreement ID, Number of the Shared AP's STAs being served in the Co-BF agreement, sounding dialog token number, the list of STA AIDs being served by the Shared AP in Co-BF, and other reserved or TBD info.
If the type value within the Starting Sequence Number indicates Co-BF ICR or Coordinated sounding, the Block ACK Bitmap field will include the Co-BF necessary parameters Info to be shared with the Sharing AP for Co-BF transmission phase, particularly for the coordinated sounding process. This includes the same MAP Agreement ID listed in the Co-BF ICF, the number of non-AP STAs to be served by the Shared AP (this field not included during a multiple-sounding TXOP) during the Co-BF shared TXOP, the same Sounding Dialog Token Number listed in the Co-BF ICF as the Co-BF Instance ID, and a list of non-AP STAs the Shared AP will serve (this field not included during a multiple-sounding TXOP) during the Co-BF shared TXOP, as well as other control information as shown in FIG. 17.

According to a further set of embodiments of the present disclosure, methods and apparatus are disclosed for exchanging sounding control information of the OBSS CSI feedback transmitted by OBSS STAs to ensure that the CSI feedback can be easily detected or overheard by the OBSS AP participating in the coordinated sounding process.

Coordinated sounding is one of the key features to realize coordinated beamforming (Co-BF) between two OBSSs. In coordinated sounding, a BSS STA may estimate the DL channel which comes from the OBSS AP, and some signaling in Null-Data PPDU Announcement (NDPA) might be required to trigger an OBSS NDP. However, to prevent the OBSS packet decoding burden on the STA side, NDPA and BFRP Trigger frame are transmitted only towards the in-BSS stations. Therefore, an AP needs to ‘overhear’ the required OBSS channel feedback matrix from the OBSS stations. In this contribution, we propose a method to improve the ‘overhearing’ performance to realize Co-BF.

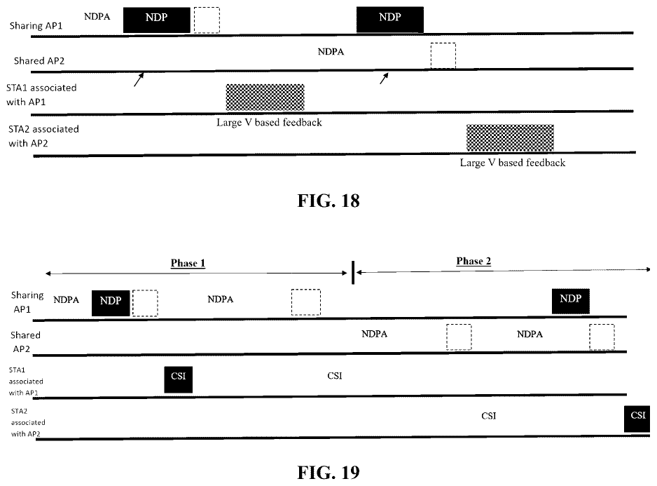

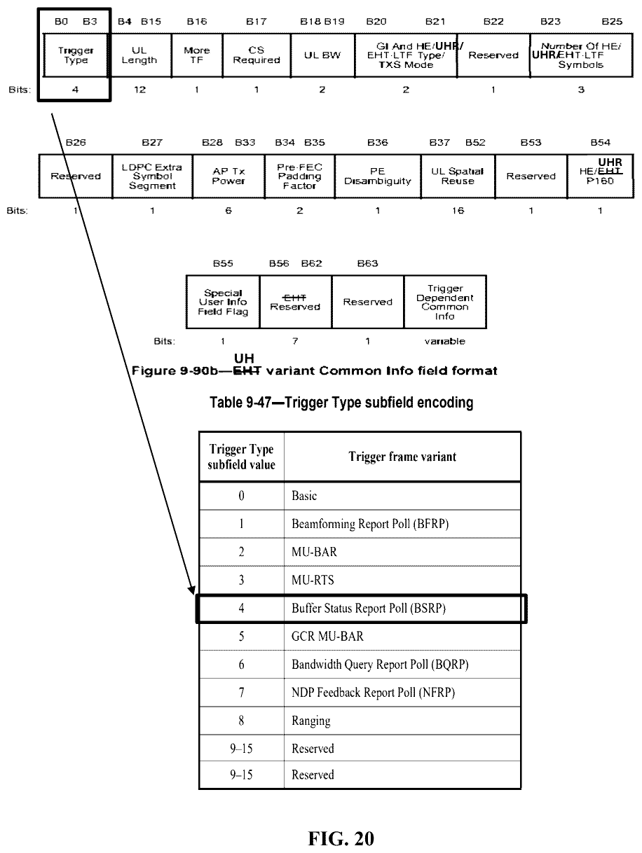

FIG. 18 is an example joint sounding sequence showing a joint sounding process. FIG. 18 shows sounding that happens in one BSS at a time in a case that 2 APs and 1 STA per AP are involved. FIG. 19 is an example sequential sounding sequence showing a sequential sounding process. FIG. 19 shows sounding that happens in one BSS at a time in a case that 2 APs and 1 STA per AP are involved, and Phase 1 sounds STA1 in BSS1 and Phase 2 sounds STA2 in BSS2.

In a Co-Sounding Sequence, when one of the APs obtains the TXOP, it initiates a coordinated sounding sequence by sending an ICF to invite the shared AP for coordinated sounding. Through this Co-Sounding ICF, the sharing AP shares coordinated sounding information with the shared AP. The shared AP responds with an ICR to acknowledge its ability to participate in the Co-Sounding sequence during the shared TXOP. Following this, the participating APs will send a sounding sequence including NDPA+NDP+BFRP.

There are some technical problems in the existing Co-Sounding Sequence. Specifically, Co-BF eliminates OBSS interference by applying null beamforming. For this, each AP needs to know OBSS channel information. However, during the sounding procedures, OBSS CSI feedback frames do not address the AP that actually needs to utilize the OBSS CSI information. Therefore, the AP has to ‘overhear’ the OBSS CSI. Other possible solutions are additionally delivering the CSI information or using wired backhaul if implemented, but it's not recommended due to medium overhead or backhaul capacity burden. In this contribution, developers propose that the Sharing and Shared APs should exchange the UL MCS and Target Receive Power of the OBSS CSI feedback transmitted by OBSS STAs to ensure that the CSI feedback can be easily detected or overheard by the OBSS AP participating in the coordinated sounding process.

The instant application discloses a fifth embodiment of the ICF frame, that is using the Buffer Status Report Poll (BSRP) trigger frame as a Co-BF sounding ICF by setting the trigger type subfield in the UHR variant Common Info subfield to a value of 4, as illustrated in FIG. 20.

To create more space for ICF control information, a User Info field dedicated to ICF-type-specific information is added to the BSRP trigger frame, according to an embodiment of the present disclosure. A general format for this ICF info field is shown in FIG. 10A.

For the AID 12 field, a fixed value should be defined in the 802.11bn specification to identify this user info record as an ICF Info field. If this value falls within the range of 1-2006, the field will be placed immediately after the Special User Info field. If the value is greater than 2007, the field will be positioned following the User Info List.

For the ICF type, this field is used to specify the type of ICF, including options such as Coordinated Beamforming (Co-BF), Coordinated Spatial Reuse (Co-SR), Coordinated TDMA (Co-TDMA), Coordinated Restricted Target Wake Time (Co-r-TWT), In-device Coexistence (IDC), Dynamic Sub-Band Operation (DSO), Non-primary Channel Access (NPCA), Dynamic Power Save (DPS), and other types to be determined (TBD).

Because the need may arise to extend this field to accommodate more info, one bit is used as an indication flag for the presence of an extended ICF Info field.

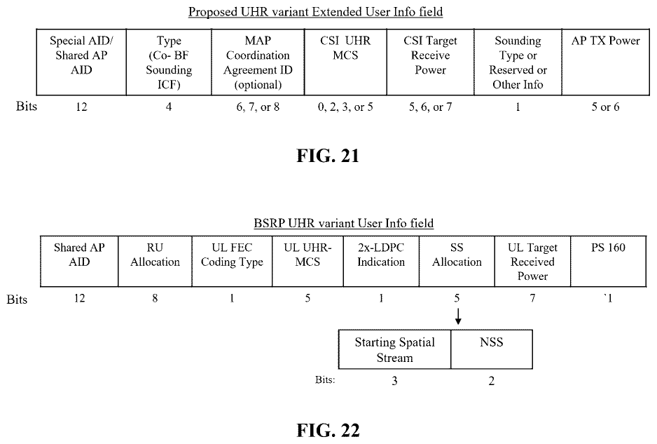

To use this general ICF Info format as a Co-BF sounding ICF, a specific value of ICF type, for instance any unallocated value from 0 to 15, namely 0 or 1, is allocated to Co-BF sounding ICF. With the ICF type set to the Co-BF sounding ICF value, the format of the ICF Info Field takes on the format shown in FIG. 21 with 6, 7, or 8 bits allotted to MAP Coordination Agreement ID (optional), 0, 2, 3, 4, or 5 bits allotted to OBSS CSI UHR MCS, 5, 6, or 7 bits allotted to OBSS CSI Target Receive Power, 5 or 6 bits allotted to AP Tx Power, and/or other remaining bits may be kept reserved or utilized for other Co-BF sounding Information (e.g., Sounding Type, . . . , etc.). Note that the location of the included fields may be changed within this ICF Info field (may be also referred to UHR Variant Extended User Info field).

For Instance, 5-bit CSI Target Receive Power is formulated as indicated in the following table 1:

### CSI Feedback Target Receive Power

TABLE 1

| CSI Target | |
|---|---|
| Receive | |
| Power Field | Description |
| 0-30 | The expected received CSI feedback signal, |
| | in units of dBm, is Target_{pwr} = −110 + 3Fᵥₐₗ, |
| | where Fᵥₐₗ is the subfield value. |
| 31 | The STA sends the CSI feedback at the STA's |
| | maximum power for the assigned CSI UHR MCS |

For Instance, 6-bit CSI Target Receive Power is formulated as indicated in the following table 2:

### CSI Feedback Target Receive Power

TABLE 2

| CSI Target | |
|---|---|
| Receive | |
| Power Field | Description |
| 0-60 | The expected received CSI feedback signal, |
| | in units of dBm, is Target_{pwr} = −110 + 1.5 Fᵥₐₗ, |
| | where Fᵥₐₗ is the subfield value. |
| 61-62 | Reserved |
| 63 | The STA sends the CSI feedback at the STA's |
| | maximum power for the assigned CSI UHR MCS |

For Instance, 7-bit CSI Target Receive Power is formulated as indicated in the following table 3:

### CSI Feedback Target Receive Power

TABLE 3

| CSI Target | |
|---|---|
| Receive | |
| Power Field | Description |
| 0-90 | The expected received CSI feedback signal, |
| | in units of dBm, is Target_{pwr} = −110 + Fᵥₐₗ, |
| | where Fᵥₐₗ is the subfield value. |
| 91-126 | Reserved |
| 127 | The STA sends the CSI feedback at the STA's |
| | maximum power for the assigned CSI UHR MCS |

For Instance, 5-bit AP Tx Power subfield indicates the AP's combined transmit power at the transmit antenna connector of all the antennas. The transmit power in dBm/20 MHz, P_{TX}, is calculated as P_{TX}=−20+2 Fᵥₐₗ, where Fᵥₐₗ is the value of the AP Tx Power subfield, except for the value 31, which is reserved.

For Instance, 6-bit AP Tx Power subfield indicates the AP's combined transmit power at the transmit antenna connector of all the antennas. The transmit power in dBm/20 MHz, P_{TX}, is calculated as P_{TX}=−20+Fᵥₐₗ, where Fᵥₐₗ is the value of the AP Tx Power subfield, except for values above 60, which are reserved.

In the coordinated sounding, the CSI UHR MCS may be a fixed value which is pre-defined in the IEEE 802.11bn specification. This value may be set to zero, then the STA's transmit power is that used for UHR MCS 0. Alternatively, other UHR MCS levels may be used. In such cases, the inclusion of the CSI UHR MCS in the coordinated sounding ICF trigger frame might not be necessary.

The values included in the CSI UHR MCS, CSI Target Receive Power, and AP Tx Power are based on the worst-case scenario for all OBSS STAs to ensure that the OBSS CSI feedback transmitted by the UHR non-AP STAs can be easily detected or overheard by the OBSS AP participating in the coordinated sounding process.

One approach is to incorporate these values into the Common Info (e.g., AP Tx Power) and the User Info fields (e.g., UHR UL MCS and Target Receive Power) of the Beamforming Report Poll (BFRP). This BFRP is sent by the Shared AP to its associated non-AP STAs when they are required to transmit their OBSS CSI reports, enabling the Sharing AP to overhear and collect this feedback.

Then, each STA computes its TX Power for the OBSS CSI report based on the following equation using the OBSS CSI Target RX Power and the computed Path-Loss from the RSSI as

$${Tx}_{pwr}^{STA} = {PL}_{DL} + {TargetRx}_{pwr}$$

Where the TargetRx_{pwr} is the CSI Target Receive Power by the OBSS Sharing AP and the PL_{DL} is the downlink pathloss between the Shared AP's associated STA and OBSS Sharing AP. This PL_{DL} can be calculated based on the NDP signal transmitted by the OBSS Sharing AP before the BFRP or based on the periodic beacon signals transmitted by the OBSS Sharing AP that can be detected by the Shared AP's associated STA.

Another approach is let these calculations done by the Shared AP transmitting the BFRP by adjusting the Target Receive Power field for each User Info field within the BFRP trigger frame to align with the OBSS CSI Target Receive Power value included in the ICF frame.

The regular User Info Field for the BSRP trigger frame, for all other AID12 that are not specially allocated, is formatted according to FIG. 22.

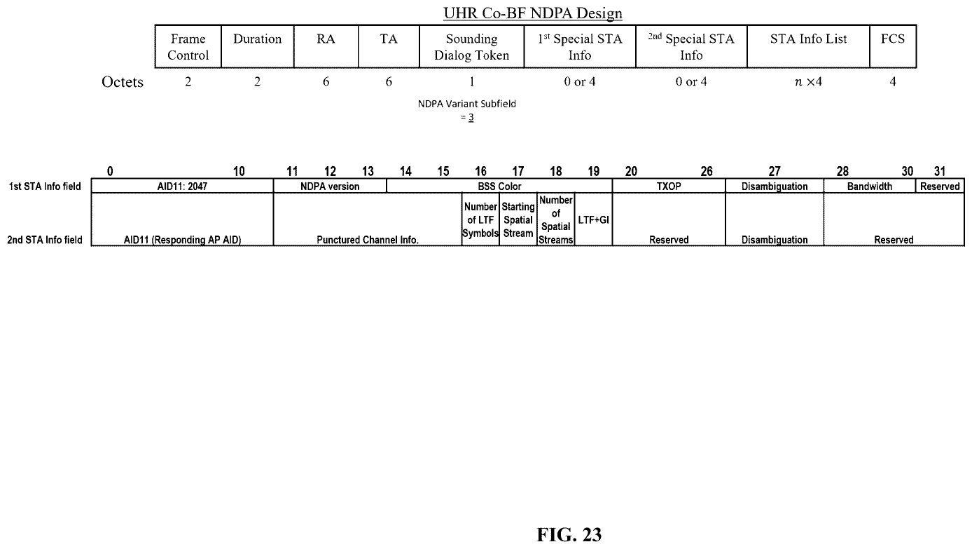

Other necessary parameters required by the Shared AP to transmit its NDP during the Coordinated Sounding phase are included within a Special STA Info field in the NDP Announcement frame with EHT variant indication as shown in the FIG. 23.

The solicited response to a Co-Sounding ICR trigger frame is a Co-sounding Initial Control Response (ICR) trigger-based frame. The main purpose of the Co-sounding ICR trigger-based frame is to enable the Shared AP to acknowledge its ability to participate in the Co-sounding transmission with the Shared AP during the shared TXOP and declare the necessary parameters for the OBSS CSI feedback transmission by OBSS STAs to enhance the reliability of the overhearing process. In this disclosure, it is proposed to design the Co-BF ICR frame based on a multi-STA BlockAck (BA) frame. From the BlockAck frame on which it is based, the Co-BF ICR frame inherits the MAC Frame Type of 1 for a control frame and the subtype of 9 for a BlockAck frame. FIG. 13 illustrates a Co-BF ICR frame, according to an embodiment.

The Shared AP includes up to one “Per AID TID Info” fields within the Multi-STA BA frame, sent to the Sharing AP: one Per AID TID Info field to acknowledge its ability, with an indication of readiness, to participate in the Co-sounding transmission during shared TXOP, and to declare other control info.

The Per AID TID Info field includes an AID TID info subfield, a Block Ack Starting Sequence Control subfield and a Block Ack Bitmap subfield. The “Per AID TID Info” field can be further subdivided as follows:
An AID TID Info subfield format contains the following subfields as illustrated in FIG. 14:
   a. 11 bits to indicate the AID
   b. 1 bit for Ack Type
   c. 4 bits for TID

According to the IEEE 802.11 standard, the AID 11 subfield carries the 11 least significant bits (LSBs) of the AID of the AP/non-AP STA for which the Per AID TID Info subfield is intended. The format of the Per AID TID Info subfield depends on the value of the AID11 subfield. If the Multi-STA BA frame is sent to an AP, the AID11 subfield is set to 0. A value of 2045 in the AID11 subfield is used as an identifier for any unassociated STA. If the AID11 subfield is set to 2045, then the ACK Type subfield and TID subfield are set to 0 and 15, respectively.

The value of the 1 bit ACK Type and 4 bits TID combined are used to indicate if this Per AID TID Info is sent for Ack, BA, or other control info, according to FIG. 15:
Regarding the one Per TID Info field that will be used to ACK the Co-BF MU-BAR ICF, it may have the same format as ACK=0 and TID=0-7.
Regarding the one Per TID Info field that will be used to ACK the new type or ranging Co-BF ICF, it can have the same format as ACK=1 and TID=14 or ACK=1 and TID=15.
Alternately, one of the reserved values can be utilized to ACK the receiving of any ICF in general, e.g. ACK=0 and TID=14.
One reserved value can be repurposed to indicate the intended use of the “Per AID TID Info” field: for conveying other control info, e.g. (Co-BF, In-Device Coexistence (IDC), Link Adaptation, MAP coordination, Intermediate FCS, Non-Primary Channel Access (NPCA), Dynamic Sub-band Operation (DSO), . . . , etc.), as presented in FIG. 16.

In further addressing the contents of the “Per AID TID Info” field, reference is made to FIG. 17.
The Block ACK Starting Sequence Control subfield is repurposed to contain metadata about Co-BF control info in the Fragment Number and Starting Sequence Number subfields.
   a. Fragment Number subfield is known to indicate the length of the BlockAck Bitmap, but is repurposed to indicate the length of the control info included in the Block Ack bitmap subfield.
   b. Starting Sequence Number is known to indicate the starting sequence number, but in embodiments the first 4 bits are used to indicate the type of control info, for instance:
      i. Value 0: indicates Co-BF ICR or Coordinated sounding.
      ii. Values 1-15: Reserved for other control info, In-Device Coexistence (IDC), Link Adaptation, MAP coordination, Intermediate FCS, Non-Primary Channel Access (NPCA), Dynamic Sub-band Operation (DSO), among other types of control information.
   The presence of Co-BF ICR and other TBD control info may be indicated by any allocated value of the type subfield within a range of 0-15.
      iii. The remaining 8 bits may be reserved for Common Control Info or other future use.
The Block ACK Bitmap subfield may be used to indicate the info parameters including MAP Agreement ID, Number of the Shared AP's STAs being served in the Co-BF agreement, sounding dialog token number, the list of STA AIDs being served by the Shared AP in Co-BF, and other reserved or TBD info.

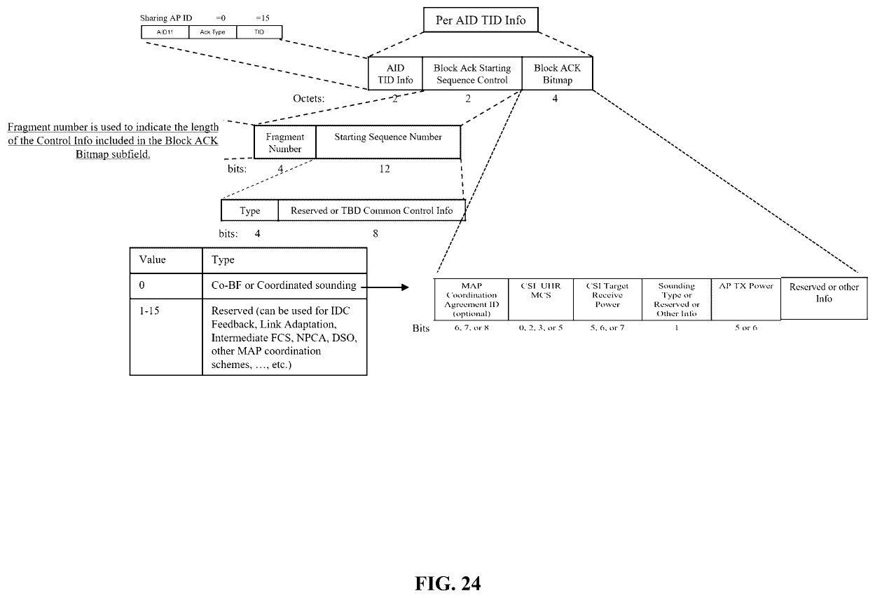

If the type value within the Starting Sequence Number indicates Co-BF ICR or Coordinated sounding ICR, the Block ACK Bitmap field will include the Co-BF necessary parameters Info to be shared with the Sharing AP for Co-BF transmission phase, particularly for the coordinated sounding process. This includes the same MAP Agreement ID listed in the Co-sounding ICF, 0, 2, 3, 4, or 5 bits allotted to OBSS CSI UHR MCS, 5, 6, or 7 bits allotted to OBSS CSI Target Receive Power, 5 or 6 bits allotted to AP Tx Power, as well as other control information as shown in FIG. 24.

One approach is to incorporate these values into the Common Info and User Info fields of the Beamforming Report Poll (BFRP). This BFRP is sent by the Sharing AP to its associated non-AP STAs when they are required to transmit their OBSS CSI reports, enabling the Shared AP to overhear and collect this feedback.

Then, each STA computes its TX Power for the OBSS CSI report based on the following equation using the OBSS CSI Target RX Power and the computed Path-Loss from the RSSI as

$${Tx}_{pwr}^{STA} = {PL}_{DL} + {TargetRx}_{pwr}$$

Where the TargetRx_{pwr} is the CSI Target Receive Power by the OBSS shared AP and the PL_{DL} is the downlink pathloss between the Sharing AP's associated STA and OBSS shared AP. This PL_{DL} can be calculated based on the NDP signal transmitted by the OBSS Shared AP before the BFRP or based on the periodic beacon signals transmitted by the OBSS Shared AP that can be detected by the Sharing AP's associated STA.

Another approach is let these calculations done by the Sharing AP transmitting the BFRP by adjusting the Target Receive Power field for each User Info field within the BFRP trigger frame to align with the OBSS CSI Target Receive Power value included in the ICR frame.

As for the 1^{st} Sounding in each Phase, the TX Power calculation for the CSI Report Frame follows the current 802.11 procedure, that is, the Path Loss is computed with the AP Tx Power indicated in the Common Info field of BFRP and with the RSSI measured on receiving the BFRP. Since the Target UL RX Power is indicated in the UHR variant User Info field, the TX Power for the CSI Report Frame is computed by the following equation,

$${Tx}_{pwr}^{STA} = {PL}_{DL} + {TargetRx}_{pwr}$$

As for the 2^{nd} Sounding in Phase 1, the TX Power calculation for the CSI Report Frame in each non-AP STA side is the same as the equation above. However, the AP Tx Power in the Common Info field of BFRP and the Target RX Power in the UHR variant User Info field of BFRP should be accurately indicated. The BFRP indicates the shared AP's TX Power and the shared AP's Target RX Power, even if the BFRP would be transmitted from the Sharing AP. We assume the Sharing AP to have already obtained the shared AP's Tx Power and Shared AP's Target RX Power through the ICR exchange before the Phase 1 sounding begins.

As for the 1^{st} and 2^{nd} Sounding in Phase 2, the TX Power calculation for the CSI Report Frame in each non-AP STA side is the same as the equation above with no change from the previous two cases. However, the BFRP indicates the Sharing AP's TX Power and the Sharing AP's Target RX Power, even if the BFRP would be transmitted from the Shared AP. We propose the Shared AP to obtain the Sharing AP's TX Power through the ICF exchange before the Phase 1 sounding begins.

The RSSI for the 2^{nd} Sounding in each Phase can be measured upon receiving the NDP from the OBSS AP.

The instant application discloses a sixth embodiment of the ICF frame, that is using the Buffer Status Report Poll (BSRP) trigger frame as a Co-BF sounding ICF by setting the trigger type subfield in the UHR variant Common Info subfield to a value of 4, as illustrated in FIG. 20.

To create more space for ICF control information, a User Info field dedicated to ICF-type-specific information is added to the BSRP trigger frame, according to an embodiment of the present disclosure. A general format for this ICF info field is shown in FIG. 10A.

For the AID 12 field, a fixed value should be defined in the 802.11bn specification to identify this user info record as an ICF Info field. If this value falls within the range of 1-2006, the field will be placed immediately after the Special User Info field. If the value is greater than 2007, the field will be positioned following the User Info List.

For the ICF type, this field is used to specify the type of ICF, including options such as Coordinated Beamforming (Co-BF), Coordinated Spatial Reuse (Co-SR), Coordinated TDMA (Co-TDMA), Coordinated Restricted Target Wake Time (Co-R-TWT), In-device Coexistence (IDC), Dynamic Sub-Band Operation (DSO), Non-primary Channel Access (NPCA), Dynamic Power Save (DPS), and other types to be determined (TBD).

Because the need may arise to extend this field to accommodate more info, one bit is used as an indication flag for the presence of an extended ICF Info field.

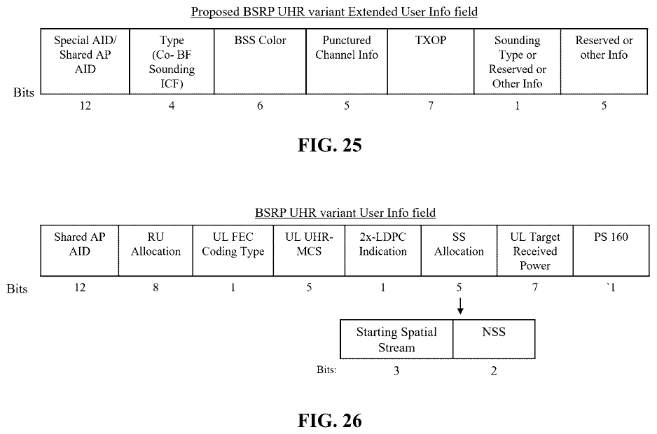

To use this general ICF Info format as a Co-BF sounding ICF, a specific value of ICF type, for instance any unallocated value from 0 to 15, namely 0 or 1, is allocated to Co-BF sounding ICF. With the ICF type set to the Co-BF sounding ICF value, the format of the ICF Info Field takes on the format shown in FIG. 25 with 6 bits allotted to BSS Color, 7 bits allotted to TXOP, 5 bits allotted to Punctured Channel Info, and other remaining bits may be kept reserved or utilized for other Co-BF Information (e.g., Sounding Type, MAP Coordination Agreement ID, . . . , etc.). Note that the location of the included fields may be changed within this ICF Info field (may be also referred to UHR Variant Extended User Info field).

Regarding the Punctured Channel Info, it can be formatted in 5 bits, as in IEEE 802.11be-2024 Table 36-30—Definition of the Punctured Channel Information field in the U-SIG for an EHT MU PPDU using non-OFDMA transmissions. The contents of this table are incorporated herein by reference.

The regular User Info Field for the BSRP trigger frame, for all other AID12 that are not specially allocated, is formatted according to FIG. 26.

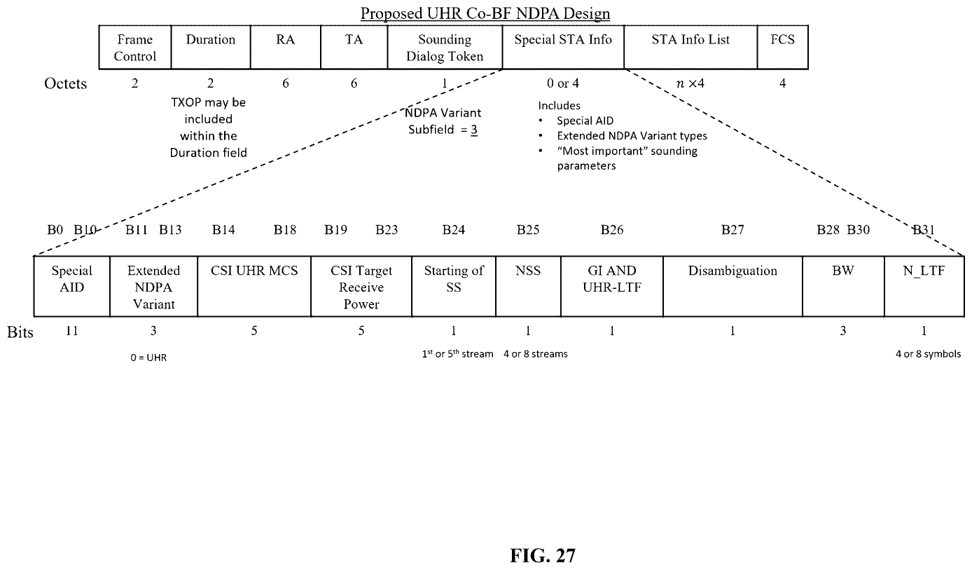

Other necessary parameters required by the Shared AP to transmit its NDP during the Coordinated Sounding phase are included within a Special STA Info field in the NDP Announcement frame with EHT variant indication as shown in the FIG. 27.

The UHR Co-BF NDPA Variant includes one 4-byte Special NDPA STA Info (e.g. the Special STA Info in FIG. 27) field that comes immediately after the Sounding Dialog Token field and before the list of 4-byte STA Info fields.

The Special NDPA STA Info field (e.g. the Special STA Info in FIG. 27) includes the NDPA version identifier and other necessary info to be shared with the shared AP and participated UHR STAs for the coordinated sounding transmissions.

With reference to the above fifth embodiment, such example special NDPA STA Info field includes the following.

Special AID or Shared AP's Association Identifier AID 11, whose value is greater than 2007. If a Special AID is included, this special AID is known to all UHR STAs. If this field includes a Shared AP's AID 11, This AID has to be assigned to the shared AP by the Sharing AP during the MAP coordination negotiation phase.

NDPA version Identifier is used to identify the NDPA variant type (e.g., value of 0 for UHR and values 1 to 7 are reserved for beyond UHR variants).

Such example special NDPA STA Info field further includes Bandwidth (3 bits) that is set to 0 for 20 MHz; set to 1 for 40 MHz; set to 2 for 80 MHz; set to 3 for 160 MHz; set to 4 for 320 MHz-1; and set to 5 for 320 MHz-2. Values 6 and 7 are Reserved.

Such example special NDPA STA Info field further includes Starting of Spatial Stream in (1 bit); Number of Spatial Streams (NSS) in (1 bit); GI AND UHR-LTF Type (1 bit); Number of LTF (N_LTF) (1 bit); bit B27 is the Disambiguation bits and is set to 1 to avoid the wrong detection of AID by legacy devices, particularly the VHT devices; CSI UHR MCS (0, 2, 3, 4, or 5 bits); CSI report Target Receive Power (5, 6 or 7 bits), or other Co-BF Info. Note that the location of the included fields may be changed within this Special STA Info field.

For instance, 1-bit Starting Spatial Stream may be set to 0 or 1 for the 1st or 5th streams, respectively, and 1-bit Number of spatial streams may be set to 0 or 1 for the 4 or 8 streams, respectively. The 1-bit LTF+GI may be set to 0 or 1 for 2×LTF+0.8 us GI or 2×LTF+1.6 us GI, respectively.

For Instance, 5-bit CSI Target Receive Power is formulated as indicated in the aforementioned table 1.

For Instance, 6-bit CSI Target Receive Power is formulated as indicated in the aforementioned table 2.

For Instance, 7-bit CSI Target Receive Power is formulated as indicated in the aforementioned table 3.

The values included in the CSI UHR MCS and CSI Target Receive Power are based on the worst-case scenario for all OBSS STAs to ensure that the CSI feedback transmitted by the UHR non-AP STAs can be easily detected or overheard by the OBSS AP participating in the coordinated sounding process.

One option is to set the CSI UHR MCS level (e.g. the aforementioned CSI UHR MCS) and the CSI Target RX Power (e.g. the aforementioned CSI Target Receive Power) in the Special STA Info field to the values required by the Sharing AP for the Sequential Sounding case.

The CSI UHR MCS level and the CSI Target RX Power for the Shared AP are set during the ICR exchange before the NDPA transmission in case of Sequential Sounding

Each STA computes its TX Power for the CSI report frame based on the following equation using the CSI Target RX Power and the computed Path-Loss from the RSSI as

$${Tx}_{pwr}^{STA} = {PL}_{DL} + {TargetRx}_{pwr} .$$

The CSI UHR MCS level and the CSI Target RX Power are set to values required by the OBSS AP among the coordinated APs in case of Joint Sounding.

Another option is the CSI UHR MCS level and the CSI Target RX Power in the Special STA Info field are set to the required values of the AP which transmits the NDPA, for the Sequential Sounding case.

That is, the CSI UHR MCS level and the CSI Target RX Power in the Special STA Info field are set to values required by the Sharing AP during the Phase 1 sounding, or set to values required by the Shared AP during the Phase 2 sounding.

The BFRP Trigger frame actually indicates the Target RX Power of the destination AP.

The CSI UHR MCS level and the CSI Target RX Power are set to values required by the OBSS AP among the coordinated APs in case of Joint Sounding.

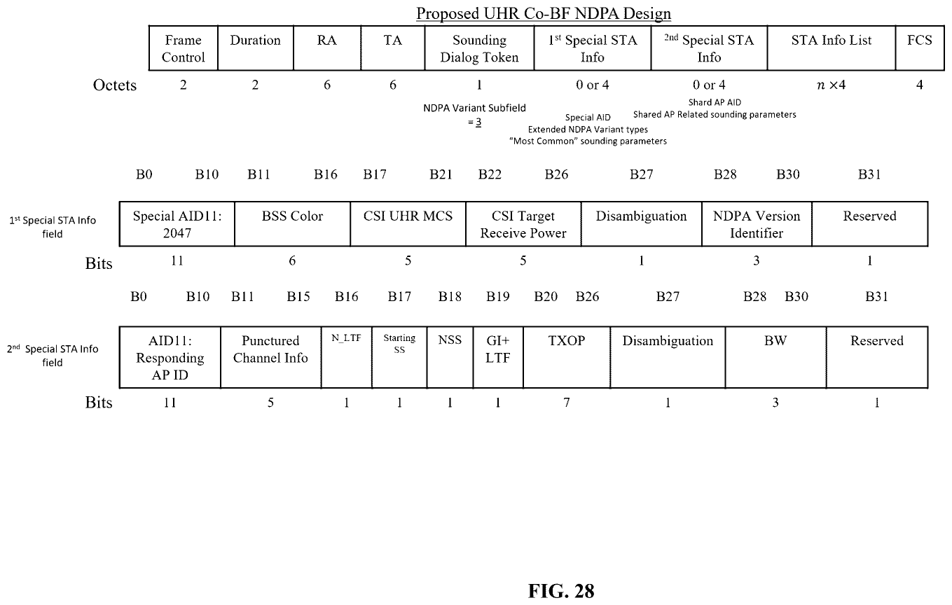

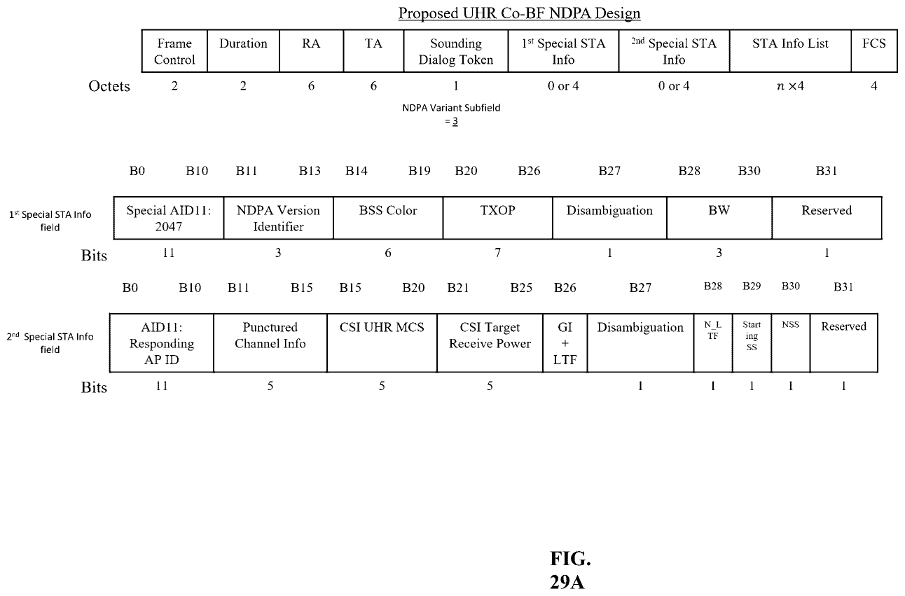

According to a further set of embodiments of the present disclosure, methods and apparatus are disclosed for exchanging sounding control information of the OBSS CSI feedback transmitted by OBSS STAs, through a NDPA frame, to ensure that the CSI feedback can be easily detected or overheard by the OBSS AP participating in the coordinated sounding process. In another embodiment, all necessary parameters required by the Shared AP to transmit its NDP during the Coordinated Sounding phase are included within a Special STA Info field in the NDP Announcement frame with EHT variant indication as shown in the FIG. 28.

The UHR Co-BF NDPA Variant includes two 4-byte Special NDPA STA Info fields that come immediately after the Sounding Dialog Token field and before the list of 4-byte STA Info fields.

The 1^{st} Special NDPA Info field includes the NDPA version identifier and other necessary common info to be shared with the shared AP and participated UHR STAs for the coordinated sounding transmissions.

With reference to this embodiment, such example 1^{st} Special NDPA STA Info field includes the following.

Special AID, whose value is greater than 2007 (e.g., 2047), known to all UHR STAs.

NDPA version Identifier is used to identify the NDPA variant type (e.g., value of 0 for UHR and values 1 to 7 are reserved for beyond UHR variants).

Such example 1^{st} special NDPA STA Info field further includes bit B27 as the Disambiguation bit which is set to 1 to avoid the wrong detection of AID by legacy devices, particularly the VHT devices; CSI UHR MCS (0, 2, 3 or 5 bits); CSI report Target Receive Power (5, 6, or 7 bits), and/or other Co-BF Info. Note that the location of the included fields may be changed within the 1^{st} Special STA Info field.

In the coordinated sounding, the CSI UHR MCS may be a fixed value which is pre-defined in the IEEE 802.11bn specification. This value may be set to zero, then the STA's transmit power is that used for UHR MCS 0. Alternatively, other UHR MCS levels may be used. In such cases, the inclusion of the CSI UHR MCS in the 1^{st} special NDPA STA might not be necessary.

For Instance, 5-bit CSI Target Receive Power is formulated as indicated in the aforementioned table 1.

For Instance, 6-bit CSI Target Receive Power is formulated as indicated in the aforementioned table 2.

For Instance, 7-bit CSI Target Receive Power is formulated as indicated in the aforementioned table 3.

The values included in the CSI UHR MCS and CSI Target Receive Power are based on the worst-case scenario for all OBSS STAs to ensure that the CSI feedback transmitted by the UHR non-AP STAs can be easily detected or overheard by the OBSS AP participating in the coordinated sounding process.

One option is to set the CSI UHR MCS level and the CSI Target RX Power in the 1^{st} Special STA Info field to the values required by the Sharing AP for the Sequential Sounding case.

The CSI UHR MCS level and the CSI Target RX Power for the Shared AP are set during the ICR exchange before the NDPA transmission in case of Sequential Sounding

Each STA computes its TX Power for the CSI report frame based on the following equation using the CSI Target RX Power and the computed Path-Loss from the RSSI as

$${Tx}_{pwr}^{STA} = {PL}_{DL} + {TargetRx}_{pwr}$$

The CSI UHR MCS level and the CSI Target RX Power are set to values required by the OBSS AP among the coordinated APs in case of Joint Sounding.

Another option is the CSI UHR MCS level and the CSI Target RX Power in the 1^{st} Special STA Info field are set to the required values of the AP which transmits the NDPA, for the Sequential Sounding case.

That is, the CSI UHR MCS level and the CSI Target RX Power in the 1^{st} Special STA Info field are set to the Sharing AP1 during the Phase 1 sounding, and set to the Shared AP2 during the Phase 2 sounding.

The BFRP Trigger frame actually indicates the Target RX Power of the destination AP.

The CSI UHR MCS level and the CSI Target RX Power are set to values required by the OBSS AP among the coordinated APs in case of Joint Sounding.

The 2^{nd} Special NDPA STA Info field includes other necessary info to be shared with the shared AP for the coordinated sounding transmissions.

With reference to this embodiment, such example 2^{nd} special NDPA STA Info field includes the following.

Shared AP's Association Identifier AID 11. This AID has to be assigned to the shared AP by the Sharing AP during the MAP coordination negotiation phase.

Such example 2^{nd} special NDPA STA Info field further includes Bandwidth (3 bits) that is set to 0 for 20 MHz; set to 1 for 40 MHz; set to 2 for 80 MHz; set to 3 for 160 MHz; set to 4 for 320 MHz-1; and set to 5 for 320 MHz-2. Values 6 and 7 are Reserved.

Such example 2^{nd} special NDPA STA Info field further includes Starting of Spatial Stream (1 bit); Number of Spatial Streams (NSS) (1 bit); GI AND UHR-LTF Type (1 bit); Number of LTF (N_LTF) (1 bit); bit B27 is the Disambiguation bit and is set to 1 to avoid the wrong detection of AID by legacy devices, particularly the VHT devices; CSI TXOP (7 bits), and/or other Co-BF Info. Note that the location of the included fields may be changed within the 2^{nd} Special NDPA STA Info field.

For instance, 1-bit Starting Spatial Stream may be set to 0 or 1 for the 1^{st} or 5th streams, respectively, and 1-bit Number of spatial streams may be set to 0 or 1 for the 4 or 8 streams, respectively. The 1-bit LTF+GI may be set to 0 or 1 for 2×LTF+0.8 us GI or 2×LTF+1.6 us GI, respectively.

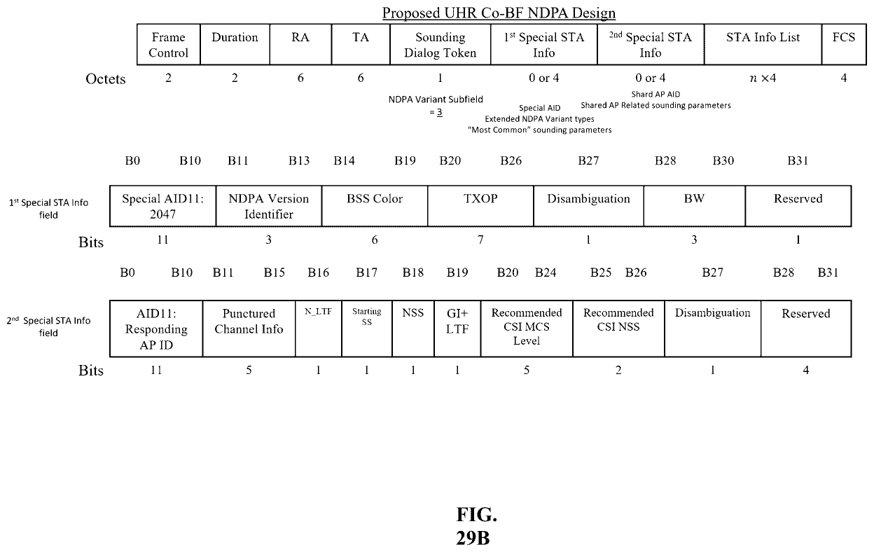

In another embodiment, all necessary parameters required by the Shared AP to transmit its NDP during the Coordinated Sounding phase are included within a Special STA Info field in the NDP Announcement frame with EHT variant indication as shown in the FIG. 29A.

The UHR Co-BF NDPA Variant includes two 4-byte Special NDPA STA Info fields that come immediately after the Sounding Dialog Token field and before the list of 4-byte STA Info fields.

The 1^{st} Special NDPA Info field includes the NDPA version identifier and other necessary common info to be shared with the shared AP and participated UHR STAs for the coordinated sounding transmissions.

With reference to this embodiment, such an example special NDPA STA Info field includes the following.

Special AID, whose value is greater than 2007 (e.g., 2047), known to all UHR STAs.

NDPA version Identifier is used to identify the NDPA variant type (e.g., value of 0 for UHR and values 1 to 7 are reserved for beyond UHR variants).

Such example 1^{st} special NDPA STA Info field further includes bit B27 as the Disambiguation bit which is set to 1 to avoid the wrong detection of AID by legacy devices, particularly the VHT devices; TXOP (7 bits); and/or other Co-BF Info. Note that the location of the included fields may be changed within the 1^{st} Special STA Info field.

Such example 1^{st} special NDPA STA Info field further includes Bandwidth (3 bits) that is set to 0 for 20 MHz; set to 1 for 40 MHz; set to 2 for 80 MHz; set to 3 for 160 MHz; set to 4 for 320 MHz-1; and set to 5 for 320 MHz-2. Values 6 and 7 are Reserved.

The 2^{nd} Special NDPA Info field includes other necessary info to be shared with the coordinating or coordinated AP for the coordinated sounding transmissions.

Each time the coordinating or coordinated AP transmits a UHR Co-BF NDPA frame, it may include the 1^{st} and 2^{nd} Special STA Info fields. As a result, the NDPA format will be the same in the entire coordinated sounding process.

Another option is the 1^{st} Special STA Info field is always included in the UHR Co-BF NDPA frame. However, the 2^{nd} Special STA Info field can be included in the UHR Co-BF NDPA when the following NDP is transmitted by the OBSS AP.

In the 1^{st} Sounding in each Phase, the Special STA Info fields may not be needed in the NDPA since the 1^{st} sounding only follows the current 802.11 sounding sequence.

With reference to this embodiment, such example 2^{nd} special NDPA STA Info field includes the following.

Shared AP's Association Identifier AID 11. This AID has to be assigned to the shared AP by the Sharing AP during the MAP coordination negotiation phase.

Such example 2^{nd} special NDPA STA Info field further includes Starting of Spatial Stream (1 bit); Number of Spatial Streams (NSS) (1 bit); GI AND UHR-LTF Type (1 bit); Number of LTF (N_LTF) (1 bit); bit B27 as the Disambiguation bit which is set to 1 to avoid the wrong detection of AID by legacy devices, particularly the VHT devices; CSI UHR MCS (0, 2, 3, 4, or 5 bits); CSI report Target Receive Power (5, 6, or 7 bits), and/or other Co-BF Info (e.g., AP Tx Power). Note that the location of the included fields may be changed within the 2^{nd} Special STA Info field.

For instance, 1-bit Starting Spatial Stream may be set to 0 or 1 for the 1^{st} or 5th streams, respectively, and 1-bit Number of spatial streams may be set to 0 or 1 for the 4 or 8 streams, respectively. The 1-bit LTF+GI may be set to 0 or 1 for 2×LTF+0.8 us GI or 2×LTF+1.6 us GI, respectively.

For Instance, 5-bit CSI Target Receive Power is formulated as indicated in the aforementioned table 1.

For Instance, 6-bit CSI Target Receive Power is formulated as indicated in the aforementioned table 2.

For Instance, 7-bit CSI Target Receive Power is formulated as indicated in the aforementioned table 3.

The values included in the CSI UHR MCS and CSI Target Receive Power are based on the worst-case scenario for all OBSS STAs to ensure that the CSI feedback transmitted by the UHR non-AP STAs can be easily detected or overheard by the OBSS AP participating in the coordinated sounding process.

One option is to set the CSI UHR MCS level and the CSI Target RX Power in the 2^{nd} Special STA Info field to the values required by the Sharing AP for the Sequential Sounding case.

The CSI UHR MCS level and the CSI Target RX Power for the Shared AP are set during the ICR exchange before the NDPA transmission in case of Sequential Sounding.

Each STA computes its TX Power for the CSI report frame based on the following equation using the CSI Target RX Power and the computed Path-Loss from the RSSI as

$${Tx}_{pwr}^{STA} = {PL}_{DL} + {TargetRx}_{pwr} .$$

The CSI UHR MCS level and the CSI Target RX Power are set to values required by the OBSS AP among the coordinated APs in case of Joint Sounding.

Another option is the CSI UHR MCS level and the CSI Target RX Power in the 2^{nd} Special STA Info field are set to the required values of the AP which transmits the NDPA, for the Sequential Sounding case.

That is, the CSI UHR MCS level and the CSI Target RX Power in the 2^{nd} Special STA Info field are set to values required by the Sharing AP1 during the Phase 1 sounding, or set to values required by the Shared AP2 during the Phase 2 sounding.

The BFRP Trigger frame actually indicates the Target RX Power of the intended AP.

The third option in sequential sounding involves the Sharing AP utilizing the 2^{nd} Special STA Info field in the NDPA frame it transmits. In this field, the Sharing AP specifies the required OBSS CSI MCS level and CSI Target Receive Power that the Shared AP should include in its BFRP to request OBSS CSI feedback during the second phase. Additionally, the Shared AP can obtain the Sharing AP's Tx Power value to include in that BFRP from the BFRP transmitted by the Sharing AP during the first phase.

Similarly, the Shared AP may utilize the 2^{nd} Special STA Info field in the NDPA frame it transmits in the second phase to specify the required OBSS CSI MCS level and CSI Target Receive Power that the Sharing AP should include in its BFRP to request OBSS CSI feedback. Additionally, the Sharing AP can obtain the Shared AP's Tx Power value to include in that BFRP from any previous BFRP transmitted by the Shared AP. Or, the Shared AP may utilize the 2^{nd} Special STA Info field in the NDPA frame it transmits in the second phase to specify the required OBSS CSI MCS level, CSI Target Receive Power and the Shared AP's Tx Power that the Sharing AP should include in its BFRP to request OBSS CSI feedback.

Another way, the Shared AP may utilize the ICR exchange with the Sharing AP that precedes the coordinating sounding process to indicate to the Sharing AP its required MCS level, Target Receive Power, and AP Tx Power values.

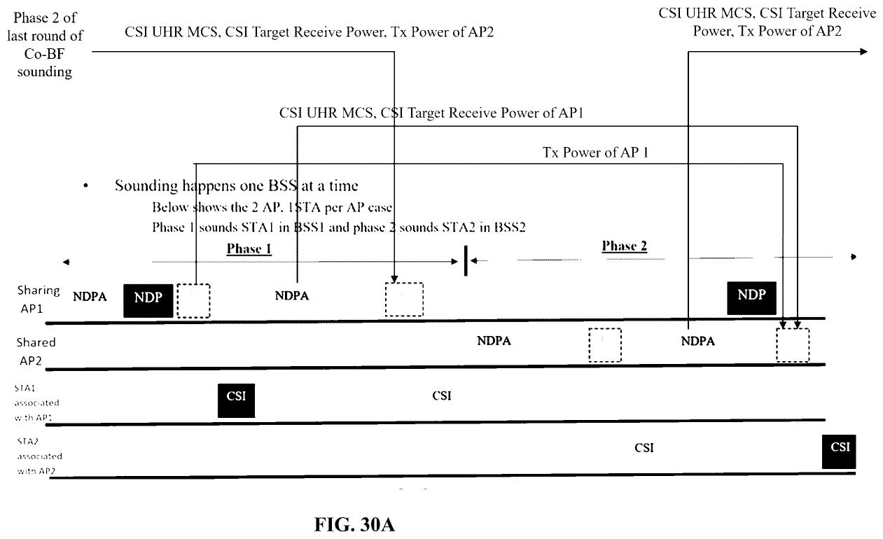

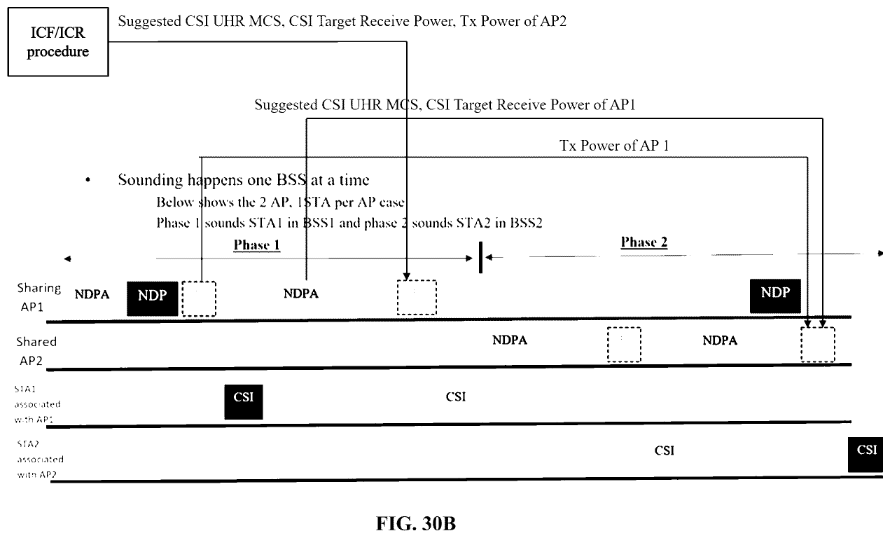

These two operations included in the third option are shown in the FIG. 30A and FIG. 30B.

The CSI UHR MCS level and the CSI Target RX Power are set to values required by the OBSS AP among the coordinated APs in case of Joint Sounding.

In another embodiment, all necessary parameters required by the Shared AP to transmit its NDP during the Coordinated Sounding phase are included within a Special STA Info field in the NDP Announcement frame with EHT variant indication as shown in the FIG. 30.

The UHR Co-BF NDPA Variant includes two 4-byte Special NDPA STA Info fields that come immediately after the Sounding Dialog Token field and before the list of 4-byte STA Info fields.

The 1^{st} Special NDPA Info field includes the NDPA version identifier and other necessary common info to be shared with the shared AP and participated UHR STAs for the coordinated sounding transmissions.

With reference to this embodiment, such an example special NDPA STA Info field includes the following.

Special AID, whose value is greater than 2007 (e.g., 2047), known to all UHR STAs.

NDPA version Identifier is used to identify the NDPA variant type (e.g., value of 0 for UHR and values 1 to 7 are reserved for beyond UHR variants).

Such example 1^{st} special NDPA STA Info field further includes bit B27 as the Disambiguation bit which is set to 1 to avoid the wrong detection of AID by legacy devices, particularly the VHT devices; TXOP (7 bits); and/or other Co-BF Info. Note that the location of the included fields may be changed within the 1^{st} Special STA Info field.

Such example 1^{st} special NDPA STA Info field further includes Bandwidth (3 bits) that is set to 0 for 20 MHz; set to 1 for 40 MHz; set to 2 for 80 MHz; set to 3 for 160 MHz; set to 4 for 320 MHz-1; and set to 5 for 320 MHz-2. Values 6 and 7 are Reserved.

The 2^{nd} Special NDPA Info field includes other necessary info to be shared with the shared AP for the coordinated sounding transmissions.

With reference to this embodiment, such example 2^{nd} special NDPA STA Info field includes the following.

Shared AP's Association Identifier AID 11. This AID has to be assigned to the shared AP by the Sharing AP during the MAP coordination negotiation phase.

Such example 2^{nd} special NDPA STA Info field further includes Starting of Spatial Stream (1 bit); Number of Spatial Streams (NSS) (1 bit); GI AND UHR-LTF Type (1 bit); Number of LTF (N_LTF) (1 bit); bit B27 as the Disambiguation bit which is set to 1 to avoid the wrong detection of AID by legacy devices, particularly the VHT devices; AP Tx Power (5 or 6 bits); CSI report Target Receive Power (5, 6, or 7 bits), and/or other Co-BF Info (e.g., UHR MCS Level). Note that the location of the included fields may be changed within the 2^{nd} Special STA Info field.

For instance, 1-bit Starting Spatial Stream may be set to 0 or 1 for the 1^{st} or 5th streams, respectively, and 1-bit Number of spatial streams may be set to 0 or 1 for the 4 or 8 streams, respectively. The 1-bit LTF+GI may be set to 0 or 1 for 2×LTF+0.8 us GI or 2×LTF+1.6 us GI, respectively.

For Instance, 5-bit CSI Target Receive Power is formulated as indicated in the aforementioned table 1.

For Instance, 6-bit CSI Target Receive Power is formulated as indicated in the aforementioned table 2.

For Instance, 7-bit CSI Target Receive Power is formulated as indicated in the aforementioned table 3.

For Instance, 6-bit AP Tx Power subfield indicates the AP's combined transmit power at the transmit antenna connector of all the antennas. The transmit power in dBm/20 MHz, P_{TX}, is calculated as P_{TX}=−20+Fᵥₐₗ, where Fᵥₐₗ is the value of the AP Tx Power subfield, except for values above 60, which are reserved.

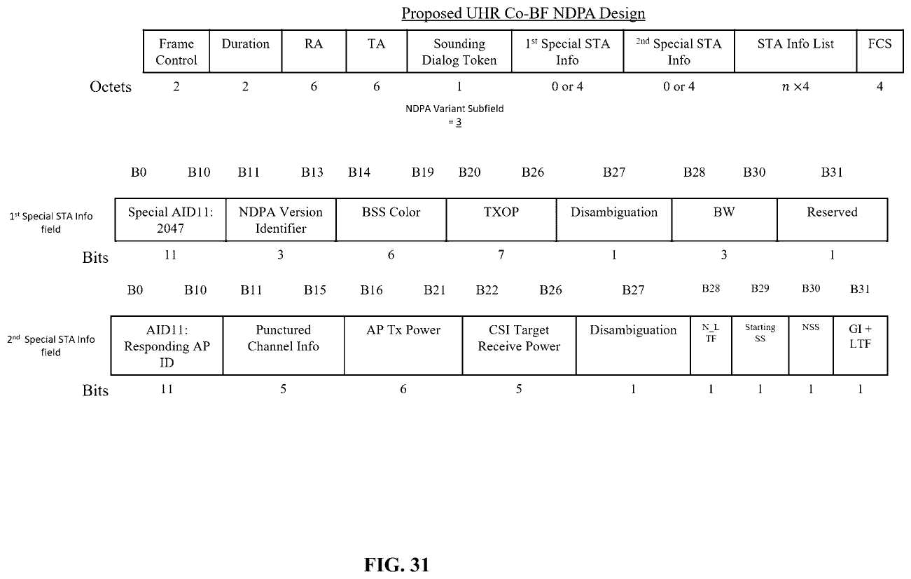

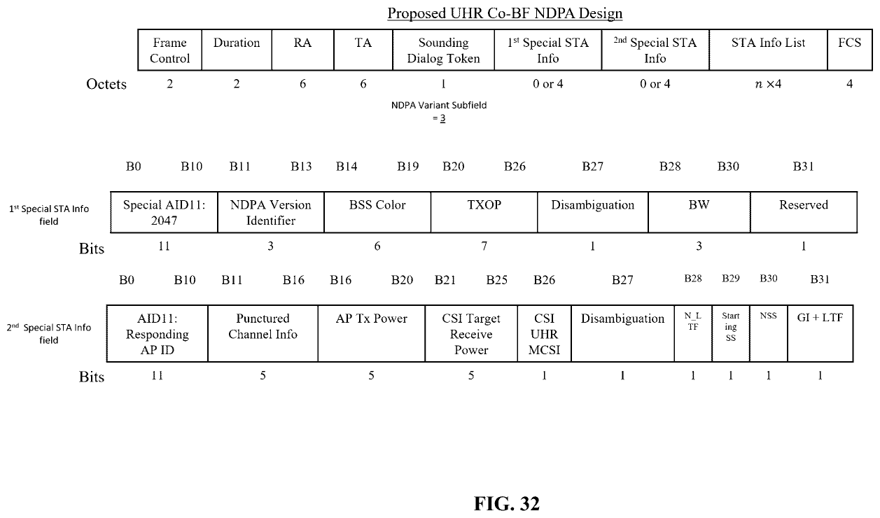

For Instance, 5-bit AP Tx Power subfield indicates the AP's combined transmit power at the transmit antenna connector of all the antennas. The transmit power in dBm/20 MHz, P_{TX}, is calculated as P_{TX}=−20+2 Fᵥₐₗ, where Fᵥₐₗ is the value of the AP Tx Power subfield, except for the value 31, which is reserved. In this case, as shown in FIG. 31, there will still be one reserved bit within the 2^{nd} Special STA Info field which may be used for CSI UHR MCS level.

In a first phase, the Sharing AP includes a second Special STA Info field in the NDPA frame it transmits. In this field, the Sharing AP specifies the required OBSS CSI MCS level and CSI NSS that the Shared AP should include in its BFRP to request CSI feedback from its associated STAs during the Shared AP's cross-BSS or joint-BSS sounding phase.

In a second phase, the Shared AP includes the second Special STA Info field in its NDPA frame to specify the required OBSS CSI MCS level and CSI NSS that the Sharing AP should include in its BFRP to request CSI feedback. The Shared AP may also use this field during its own cross-BSS or joint-BSS sounding phase to indicate the CSI MCS level and CSI NSS that the Sharing AP should include in its subsequent BFRP.

The recommended CSI MCS enables the OBSS AP to set the MCS in the BFRP trigger frame sent in the next cross-BSS or joint-BSS sounding sequence. In certain embodiments, the CSI MCS field is 5 bits, starting at bit B20 in the second Special STA Info field of the NDPA, with value 31 designating “null” or no recommendation.

The recommended CSI UHR MCS and CSI NSS values are set based on a worst-case scenario across all OBSS STAs to ensure that CSI feedback transmitted by UHR non-AP STAs can be reliably detected or overheard by the OBSS AP participating in the coordinated sounding process.

After a coordinated beamforming (Co-BF) agreement is established, each AP may overhear transmissions from the other coordinating AP's nearby non-AP STAs and determine the recommended values according to the worst-case scenario.

Alternatively, during an initial Co-BF sounding process between the Sharing AP and Shared AP, each AP may set the recommended CSI MCS value to 31 (no recommendation). Based on overheard OBSS CSI reports from that process, the APs may then refine the recommended CSI MCS values for subsequent Co-BF sounding sequences to improve overhearing reliability.

In the coordinated sounding, the CSI UHR MCS may be a fixed value which is pre-defined in the IEEE 802.11bn specification. For instance, this value may be set to zero, then the STA's transmit power is that used for UHR MCS 0. Alternatively, other UHR MCS levels may also be used.

The values included in the CSI UHR MCS, CSI Target Receive Power, and AP Tx Power are based on the worst-case scenario for all OBSS STAs to ensure that the OBSS CSI feedback transmitted by the UHR non-AP STAs can be easily detected or overheard by the OBSS AP participating in the coordinated sounding process.

One option is to set the AP Tx Power and the CSI Target RX Power in the 2^{nd} Special STA Info field to the values required by the Sharing AP for the Sequential Sounding case.

The AP Tx Power and the CSI Target RX Power for the Shared AP are set during the ICR exchange before the NDPA transmission in case of Sequential Sounding

Each STA computes its TX Power for the CSI report frame based on the following equation using the CSI Target RX Power and the computed Path-Loss from the RSSI as

$${Tx}_{pwr}^{STA} = {PL}_{DL} + {TargetRx}_{pwr}$$

The AP Tx Power and the CSI Target RX Power are set to values required by the OBSS AP among the coordinated APs in case of Joint Sounding.

Another option is the AP Tx Power and the CSI Target RX Power in the 2^{nd} Special STA Info field are set to the required values of the AP which transmits the NDPA, for the Sequential Sounding case.

That is, the AP Tx Power and the CSI Target RX Power in the 2^{nd} Special STA Info field are set to values required by the Sharing AP1 during the Phase 1 sounding, or set to values required by the Shared AP2 during the Phase 2 sounding.

The BFRP Trigger frame actually indicates the Target RX Power of the intended AP.

The third option in sequential sounding involves the Sharing AP utilizing the 2^{nd} Special STA Info field in the NDPA frame it transmits. In this field, the Sharing AP specifies the required AP Tx Power and CSI Target Receive Power that the Shared AP should include in its BFRP to request OBSS CSI feedback during the second phase.

Similarly, the Shared AP may utilize the 2^{nd} Special STA Info field in the NDPA frame it transmits in the second phase to specify the required AP Tx Power and CSI Target Receive Power that the Sharing AP should include in its BFRP to request OBSS CSI feedback.

Another way, the Shared AP may utilize the ICR exchange with the Sharing AP that precedes the coordinating sounding process to indicate to the Sharing AP its required MCS level, Target Receive Power, and AP Tx Power values.

The AP Tx Power and the CSI Target RX Power are set to values required by the OBSS AP among the coordinated APs in case of Joint Sounding.

As for the 1^{st} Sounding in each Phase, the TX Power calculation for the CSI Report Frame follows the current 802.11 procedure, that is, the Path Loss is computed with the AP Tx Power indicated in the Common Info field of BFRP and with the RSSI measured on receiving the BFRP. Since the Target UL RX Power is indicated in the UHR variant User Info field, the TX Power for the CSI Report Frame is computed by the following equation,

$${Tx}_{pwr}^{STA} = {PL}_{DL} + {TargetRx}_{pwr} .$$

As for the 2^{nd} Sounding in Phase 1, the TX Power calculation for the CSI Report Frame in each non-AP STA side is the same as the equation above. However, the AP Tx Power in the Common Info field of BFRP and the Target RX Power in the UHR variant User Info field of BFRP should be accurately indicated. The BFRP indicates the shared AP's TX Power and the shared AP's Target RX Power, even if the BFRP would be transmitted from the Sharing AP. We assume the Sharing AP to have already obtained the shared AP's Tx Power and Shared AP's Target RX Power through the ICR exchange before the Phase 1 sounding begins or set it to initial reliable values until it receives the Shared AP's required parameters from the NDPA transmitted in Phase 2.

As for the 2^{nd} Sounding in Phase 2, the TX Power calculation for the CSI Report Frame in each non-AP STA side is the same as the equation above with no change from the previous two cases. However, the BFRP indicates the Sharing AP's TX Power and the Sharing AP's Target RX Power, even if the BFRP would be transmitted from the Shared AP. We propose the shared AP to obtain sharing AP's TX Power and sharing AP's Target RX Power through the NDPA transmitted in Phase 1.

The RSSI for the 2^{nd} Sounding in each Phase can be measured upon receiving the NDP from the OBSS AP.

In another embodiment, all necessary parameters required by the Shared AP to transmit its NDP during the Coordinated Sounding phase are included within a Special STA Info field in the NDP Announcement frame with EHT variant indication as shown in FIG. 29B. It will be appreciated that FIG. 29B differs from FIG. 29A chiefly in the allocations of bits within the second special NDPA STA Info Field.

The UHR Co-BF NDPA Variant includes two 4-byte Special NDPA STA Info fields that come immediately after the Sounding Dialog Token field and before the list of 4-byte STA Info fields.

The 1^{st} Special NDPA Info field includes the NDPA version identifier and other necessary common info to be shared with the shared AP and participating UHR STAs for the coordinated sounding transmissions.

With reference to this embodiment, such an example 1^{st} special NDPA STA Info field includes the following.

Special AID, whose value is greater than 2007 (e.g., 2047), known to all UHR STAs.

NDPA version Identifier is used to identify the NDPA variant type (e.g., value of 0 for UHR and values 1 to 7 are reserved for beyond UHR variants).

Such example 1^{st} special NDPA STA Info field further includes bit B27 as the Disambiguation bit which is set to 1 to avoid the wrong detection of AID by legacy devices, particularly the VHT devices; TXOP (7 bits); and/or other Co-BF Info. Note that the location of the included fields may be changed within the 1^{st} Special STA Info field.

Such example 1^{st} special NDPA STA Info field further includes Bandwidth (3 bits) that is set to 0 for 20 MHz; set to 1 for 40 MHz; set to 2 for 80 MHz; set to 3 for 160 MHz; set to 4 for 320 MHz-1; and set to 5 for 320 MHz-2. Values 6 and 7 are Reserved.

The 2^{nd} Special NDPA Info field includes other necessary info to be shared with the coordinating or coordinated AP for the coordinated sounding transmissions.

Each time the coordinating or coordinated AP transmits a UHR Co-BF NDPA frame, it may include the 1^{st} and 2^{nd} Special STA Info fields. As a result, the NDPA format will be the same in the entire coordinated sounding process.

Another option is that the 1^{st} Special STA Info field is always included in the UHR Co-BF NDPA frame. However, the 2^{nd} Special STA Info field can be included in the UHR Co-BF NDPA when the following NDP is transmitted by the OBSS AP.

In the 1^{st} Sounding in each Phase, the Special STA Info fields may not be transmitted in the NDPA since the 1^{st} sounding only follows the known 802.11 sounding sequence.

With reference to this embodiment, such example 2^{nd} special NDPA STA Info field includes the following.

Shared AP's Association Identifier AID 11. This AID has to be assigned to the shared AP by the Sharing AP during the MAP coordination negotiation phase.

Such example 2^{nd} special NDPA STA Info field further includes Starting of Spatial Stream (1 bit); Number of Spatial Streams (NSS) (1 bit); GI AND UHR-LTF Type (1 bit); Number of LTF (N_LTF) (1 bit); bit B27 as the Disambiguation bit which is set to 1 to avoid the wrong detection of AID by legacy devices, particularly the VHT devices; recommended CSI UHR MCS Level (4 or 5 bits); CSI NSS (1, 2, 3, or 4 bits), and/or other Co-BF Info (e.g., TX EVM or Target Receive Power, . . . , etc.). Note that the location of the included fields may be changed within the 2^{nd} Special STA Info field.

To explain further, with reference to FIG. 29B, 1-bit Starting Spatial Stream may be set to 0 or 1 for the 1^{st} or 5th streams, respectively, and 1-bit Number of spatial streams may be set to 0 or 1 for the 4 or 8 streams, respectively. The 1-bit GI+LTF may be set to 0 or 1 for 2×LTF+0.8 us GI or 2×LTF+1.6 us GI, respectively.

The recommended values included in the CSI UHR MCS and CSI NSS are based on the worst-case scenario for all OBSS STAs to ensure that the CSI feedback transmitted by the UHR non-AP STAs can be easily detected or overheard by the OBSS AP participating in the coordinated sounding process. With respect to FIG. 29A, Target Receive Power is no longer specified in FIG. 29B. These bits are released to carry other Co-BF info, as transmission and/or reception power may in this embodiment be directly correlated to the recommended CSI MCS level.

The Recommended CSI MCS is for the OBSS AP to set the MCS in the BFRP trigger frame sent in the next Cross-BSS sounding sequence. According to embodiments the CSI MCS may be allocated 4 bits or 5 bits, starting at B20 in the second Special STA Info Field of the NDPA. When allocated 4 bits, the values 0-9 correspond to recommending a MCS level of 0-9 respectively. Values 10-14 are reserved, with value 15 designating null, or no recommendation. When CSI MCS is allocated 4 bits, B24 becomes part of the CSI NSS subfield which itself becomes a 3-bit field. When allocated 5 bits, the values 0-17 correspond to recommending a MCS level of 0-17 respectively, with value 31 designating null, or no recommendation. The OBSS STAs can transmit the CSI Report frame with the maximum TX Power allowed in IEEE 802.11 according to the Recommended CSI MCS.

One of the values of CSI NSS field, such as in nonlimiting examples, 7, or 15, may indicate no recommended value of CSI NSS is provided or required. Furthermore, should a 3-bit or 4-bit CSI NSS be implemented, it can reside in bits B28-B30 or B28-B31 (not shown) instead of bits B25-B26 as shown in FIG. 29B.

If sequential sounding involves the Sharing AP utilizing the 2^{nd} Special STA Info field in the NDPA frame it transmits, in this field, the Sharing AP specifies the required OBSS CSI MCS level and CSI NSS that the Shared AP should include in its BFRP to request OBSS CSI feedback from its associated STAs during the second phase.

Similarly, the Shared AP may utilize the 2^{nd} Special STA Info field in the NDPA frame it transmits in the second phase to specify the required OBSS CSI MCS level and CSI NSS that the Sharing AP should include in its BFRP to request OBSS CSI feedback. The Shared AP may utilize the 2^{nd} Special STA Info field in the NDPA frame it transmits in the second phase to specify the required OBSS CSI MCS level, CSI NSS that the Sharing AP should include in its BFRP to request OBSS CSI feedback.

Alternatively to utilizing the NDPA, both the Sharing AP and Shared AP may utilize the ICF/ICR exchange that precedes the coordinating sounding process to indicate their required OBSS CSI MCS level and CSI NSS values.

Regardless of the signaling or frames used to send them, the CSI UHR MCS level and the CSI NSS are set to values required by the OBSS AP among the coordinated APs in case of Joint Sounding.

According to a further set of embodiments of the present disclosure, a MAC-level mechanism is disclosed to prevent AID conflicts between STAs that are associated with the Shared AP and those associated with the Sharing AP. As each AP may assign STA AIDs independently at the time of association, it is possible two STAs associated respectively with the Shared AP and the Sharing AP may have identical AIDs. Such conflicts can disrupt communication within the Co-BF environment, reducing efficiency and complicating coordination. The following embodiments are disclosed to resolve STAs' Address Identifier (AID) conflicts among STAs within Co-BF coordination groups.

In a first possible AID conflict resolution embodiment, each Co-BF AP group negotiates the reassignment of overlapping STA AIDs to new, non-overlapping ones. Only STAs having AID conflict issues will be assigned a new AID after negotiation between the Sharing and Shared APs. However, the negotiation may require multiple rounds, making it potentially too complex and time-consuming, and therefore not ideal.

Alternately, in a second possible AID conflict resolution embodiment, APs in a MAP coordination group would pre-negotiate distinct, non-overlapping AID ranges for their associated STAs in a one-time agreement during the Initial MAP Coordination Agreement Negotiation stage. Each AP would then communicate any updated AIDs to its associated STAs. For instance, with an AID pool of 2006 in the User Info field, AP1 and AP2 could agree on a split where AP1 uses AIDs 1-1003 and AP2 uses AIDs 1004-2006. Other AID range allocations are possible, provided they accommodate the maximum supported associated STAs for each AP in the MAP group. An AP may participate in multiple MAP coordination agreements, so including the MAP Agreement ID may help distinguish different agreements with varying AID ranges.

These embodiments allow APs participating in MAP coordination group to pre-negotiate non-overlapping AID ranges for their STAs. This is achieved through proposing an AID Range Negotiation Element and a MAP AID Range Negotiation Public Action Frame to be exchanged between the APs participating in MAP coordination group during the MAP Coordination Agreement Negotiation stage. By allocating non-overlapping AID ranges, the disclosure ensures that APs can operate without AID conflicts, enhancing the efficiency and reliability of Co-BF transmissions.

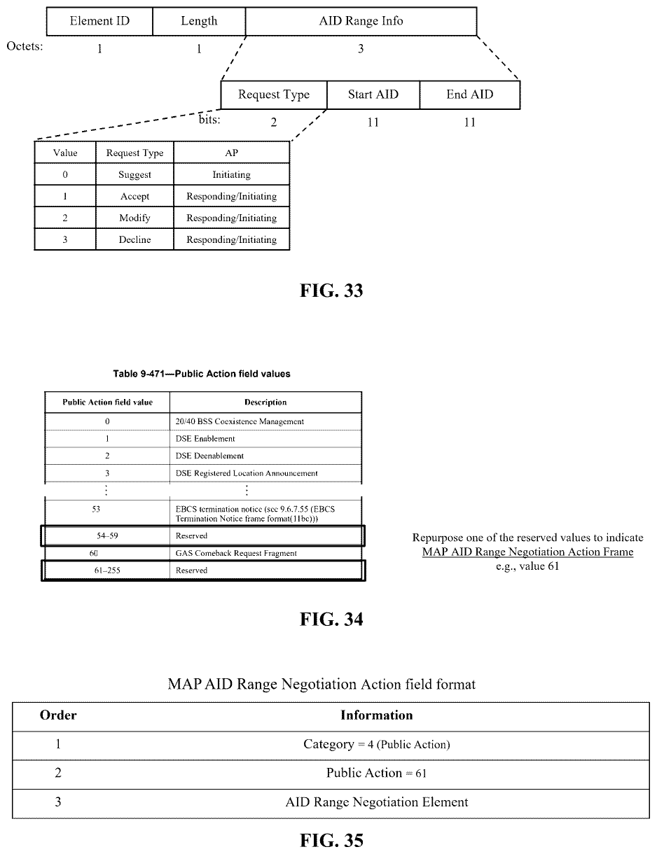

The format of the AID Range Negotiation Element is indicated in FIG. 33 and includes:
Element ID and Length fields.
AID Range Info field which includes:
   a. Request type, to be used to indicate if the suggested range split is a suggestion, acceptable, rejected, or modification.
   b. Start AID field indicates the 11 LSBs of the lowest AID value that AP can allocate to its associated STAs.
   c. End AID field indicates the 11 LSBs of the highest AID value that AP can allocate to its associated STAs.

The initiating AP may suggest certain AID range for other APs in the coordination group, and the responding APs may accept or decline/reject this range, or request to modify this range to a new one. At the end. All the APs have to agree to an acceptable AID range split to avoid the AID conflict issue. The sharing/shared AP can assign an AP ID to the shared/sharing AP from its agreed range.

This AID Range Negotiation Element can be exchanged through using a new public Action frame, according to an embodiment of the present disclosure, or through using any other control or management frames. The Public Action frames are defined in the standard to allow Inter-BSS communications, AP to unassociated-STA communications, and intra-BSS communication.

The new Public Action Frame for MAP supported AID range negotiation is defined as follows in accordance with FIG. 35. Like other Public Action Frames, it always has a Category field of value 4 indicating a public action. The next field is the action designator field, with some current uses listed in FIG. 34 along with presently reserved values. Repurposing one of these reserved values, for instance 61, may designate the Public Action Frame as a Multi AP AID Range Negotiation frame. Following the action field is the AID Range Negotiation Element field described above and in FIG. 33.

The above-described embodiments of the present disclosure serve to standardize signaling between APs and STAs, ensuring efficient setup of Co-BF transmissions. They enable precise identification of the STAs each AP will serve, enhancing clarity and coordination in MAP Co-BF groups. Embodiments provide consistent tracking of Co-BF instances and agreements.

Embodiments enhance “overhearing” performance to realize Co-BF by exchanging sounding control information of the OBSS CSI feedback transmitted by OBSS STAs. Embodiments exchange the UL MCS and Target Receive Power of the OBSS CSI feedback transmitted by OBSS STAs to ensure that the CSI feedback can be easily detected or overheard by the OBSS AP participating in the coordinated sounding process.

Embodiments enhance synchronization and minimizes conflicts in MAP environments, to ensure conflict-free communication among coordinated APs. Embodiments serve to improve reliability and efficiency in serving overlapping STAs as well as enabling versatile communication by adding critical control data. Overhead is reduced by combining acknowledgment and control info.

FIG. 2 is a schematic diagram of device 200 that may perform any or all of operations of the above methods and features explicitly or implicitly described herein, according to different embodiments of the present disclosure. For example, a computer equipped with network function may be configured as device 200. As may be appreciated by a person skilled in the art, the device 200 can represent one or more entities described herein, for example, an AP, a STA, or the like.

As shown, the device 200 may include a processor 210, such as a central processing unit (CPU) or specialized processors such as a graphics processing unit (GPU) or other such processor unit, memory 220, non-transitory mass storage 230, input-output interface 1040, network interface 250, and a transceiver 260, all of which are communicatively coupled via bi-directional bus 270. According to certain embodiments, any or all of the depicted elements may be utilized, or only a subset of the elements. Further, device 200 may contain multiple instances of certain elements, such as multiple processors, memories, or transceivers. Also, elements of the hardware device may be directly coupled to other elements without the bi-directional bus. Additionally, or alternatively to a processor and memory, other electronics, such as integrated circuits, may be employed for performing the required logical operations.

The memory 220 may include any type of non-transitory memory such as static random access memory (SRAM), dynamic random access memory (DRAM), synchronous DRAM (SDRAM), read-only memory (ROM), any combination of such, or the like. The mass storage element 230 may include any type of non-transitory storage device, such as a solid state drive, hard disk drive, a magnetic disk drive, an optical disk drive, USB drive, or any computer program product configured to store data and machine executable program code. According to certain embodiments, the memory 220 or mass storage 230 may have recorded thereon statements and instructions executable by the processor 210 for performing any of the aforementioned method operations described above.

Embodiments of the present disclosure can be implemented using electronics hardware, software, or a combination thereof. In some embodiments, the disclosure is implemented by one or multiple computer processors executing program instructions stored in memory. In some embodiments, the disclosure is implemented partially or fully in hardware, for example using one or more field programmable gate arrays (FPGAs) or application specific integrated circuits (ASICs) to rapidly perform processing operations.

It will be appreciated that, although specific embodiments of the technology have been described herein for purposes of illustration, various modifications may be made without departing from the scope of the technology. The specification and drawings are, accordingly, to be regarded simply as an illustration of the disclosure as defined by the appended claims, and are contemplated to cover any and all modifications, variations, combinations or equivalents that fall within the scope of the present disclosure. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding embodiments, the present disclosure may be implemented by using hardware only or by using software and a necessary universal hardware platform. Based on such understandings, the technical solution of the present disclosure may be embodied in the form of a software product. The software product may be stored in a non-volatile or non-transitory storage medium, which can be a compact disk read-only memory (CD-ROM), USB flash disk, or a removable hard disk. The software product includes a number of instructions that enable a computer device (personal computer, server, or network device) to execute the methods provided in the embodiments of the present disclosure. For example, such an execution may correspond to a simulation of the logical operations as described herein. The software product may additionally or alternatively include number of instructions that enable a computer device to execute operations for configuring or programming a digital logic apparatus in accordance with embodiments of the present disclosure.

Although the present disclosure has been described with reference to specific features and embodiments thereof, it is evident that various modifications and combinations can be made thereto without departing from the disclosure. The specification and drawings are, accordingly, to be regarded simply as an illustration of the disclosure as defined by the appended claims, and are contemplated to cover any and all modifications, variations, combinations or equivalents that fall within the scope of the present disclosure.

1. A communication method, comprising:
transmitting, from a first AP to a second AP, a first Null-Data PPDU Announcement (NDPA) frame comprising first sounding control information; and/or
receiving, from the second AP to the first AP, a second NDPA frame comprising second sounding control information,
wherein the first NDPA frame or the second NDPA frame comprises a first special station info field and a second special station info field, and the second special station info field carrying one or more of:
a recommended channel state information (CSI) ultra-high reliability (UHR) modulation and coding scheme (MCS) level field;
a CSI target receive power field; or
an AP transmit power field.

2. The method of claim 1, wherein the values of the recommended CSI UHR MCS level field are set according to a worst-case scenario across overlapping basic service set (OBSS) stations.

3. The method of claim 1, wherein the recommended CSI UHR MCS level field is 5 bits and located at bit B20-B24 in the second special station info field.

4. The method of claim 1, wherein value 31 of the recommended CSI UHR MCS level field designating no recommendation.

5. The method of claim 1, further comprising:
transmitting, by the first AP a first frame comprising coordinated sounding control information, wherein the coordinated sounding control information comprises the recommended CSI UHR MCS level field; and
receiving, by the first AP, a CSI report frame with a MCS level set by the STA according to the coordinated sounding control information in the first frame, wherein the first frame comprises a beamforming report poll (BFRP).

6. The method of claim 1, further comprising:
setting the recommended CSI UHR MCS level value to 31 during an initial coordinated beamforming sounding process; and/or
updating the recommended CSI UHR MCS level values based on overheard OBSS CSI reports from nearby non-AP stations.

7. The method of claim 1, wherein the first AP is a sharing AP and the second AP is a shared AP, or the first AP is a shared AP and the second AP is a sharing AP.

8. A communication method, comprising:
receiving, by a station (STA) from access point (AP), a first frame comprising coordinated sounding control information, wherein the coordinated sounding control information comprises a recommended CSI UHR MCS level field; and
transmitting, by the station to the AP, a CSI report frame with a MCS level set by the STA according to the coordinated sounding control information in the first frame, wherein the first frame comprises a beamforming report poll (BFRP).

9. The method of claim 8, wherein the AP is a sharing AP or a shared AP.

10. An apparatus, comprising:
one or more processors couple with a memory storing instructions which, when executed by the one or more processors, cause the apparatus to perform a method, the method comprising:
transmitting, from a first AP to a second AP, a first Null-Data PPDU Announcement (NDPA) frame comprising first sounding control information; and/or
receiving, from the second AP to the first AP, a second NDPA frame comprising second sounding control information,
wherein the first NDPA frame or the second NDPA frame comprises a first special station info field and a second special station info field, and the second special station info field carrying one or more of:
a recommended channel state information (CSI) ultra-high reliability (UHR) modulation and coding scheme (MCS) level field;
a CSI target receive power field; or
an AP transmit power field.

11. The apparatus of claim 10, wherein the values of the recommended CSI UHR MCS level field are set according to a worst-case scenario across overlapping basic service set (OBSS) stations.

12. The apparatus of claim 10, wherein the recommended CSI UHR MCS level field is 5 bits and located at bit B20-B24 in the second special station info field.

13. The apparatus of claim 10, wherein value 31 of the recommended CSI UHR MCS level field designating no recommendation.

14. The apparatus of claim 10, wherein the method further comprising:
transmitting, by the first AP a first frame comprising coordinated sounding control information, wherein the coordinated sounding control information comprises the recommended CSI UHR MCS level field; and
receiving, by the first AP, a CSI report frame with a MCS level set by the STA according to the coordinated sounding control information in the first frame, wherein the first frame comprises a beamforming report poll (BFRP).

15. The apparatus of claim 10, wherein the method further comprising:
setting the recommended CSI UHR MCS level value to 31 during an initial coordinated beamforming sounding process; and/or
updating the recommended CSI UHR MCS level values based on overheard OBSS CSI reports from nearby non-AP stations.

16. The apparatus of claim 10, wherein the first AP is a sharing AP and the second AP is a shared AP, or the first AP is a shared AP and the second AP is a sharing AP.

17. An apparatus, comprising:
one or more processors couple with a memory storing instructions which, when executed by the one or more processors, cause the apparatus to perform a method, the method comprising:
receiving, by a station (STA) from access point (AP), a first frame comprising coordinated sounding control information, wherein the coordinated sounding control information comprises a recommended CSI UHR MCS level field; and
transmitting, by the station to the AP, a CSI report frame with a MCS level set by the STA according to the coordinated sounding control information in the first frame, wherein the first frame comprises a beamforming report poll (BFRP).

18. The apparatus of claim 17, wherein the AP is a sharing AP or a shared AP.
